(19) United States
(12) Patent Application Publication
(10) Pub. No.: US 2014/0329553 A1
(43) Pub. Date: Nov. 6, 2014

(54) MOBILE STATION APPARATUS, COMMUNICATION SYSTEM, COMMUNICATION METHOD, AND INTEGRATED CIRCUIT

(71) Applicant: Sharp Kabushiki Kaisha, Osaka-shi, Osaka (JP)

(72) Inventors: Daiichiro Nakashima, Osaka-shi (JP); Wataru Ouchi, Osaka-shi (JP); Shoichi Suzuki, Osaka-shi (JP); Kimihiko Imamura, Osaka-shi (JP)

(73) Assignee: Sharp Kabushiki Kaisha, Osaka-shi, Osaka (JP)

(21) Appl. No.: 14/354,176

(22) PCT Filed: Sep. 20, 2012
(86) PCT No.: PCT/JP2012/074021

§ 371 Date: Apr. 25, 2014

(30) Foreign Application Priority Data
Oct. 27, 2011 (JP) 2011-235536

(51) Int. Cl. H04W 52/36

(52) U.S. Cl. CPC H04W 52/365
USPC 455/522

(57) ABSTRACT

A base station apparatus efficiently controls transmission of an uplink signal to a mobile station apparatus. A transmission power setting unit sets transmission power for a physical uplink shared channel using one of a plurality of calculated path losses. A power headroom generation unit generates a first power headroom and a second power headroom, wherein the first power headroom is information associated with a margin of transmission power and produced using a band width of a resource allocated for the physical uplink shared channel and the path loss used in the setting of the transmission power for the physical uplink shared channel, and the second power headroom is information associated with a margin of transmission power and produced, without depending on the band width of the resource allocated for the physical uplink shared channel, using a path loss that is one of the plurality of calculated path losses but that is not used in the setting of the transmission power for the physical uplink shared channel.

### TECHNICAL FIELD

The present invention relates to a mobile station apparatus capable of efficiently transmitting a signal in an uplink in a communication system including a plurality of mobile station apparatuses and a base station apparatus, and also relates to a communication system, a communication method, and an integrated circuit.

### BACKGROUND ART

Specifications of cellular mobile communication in terms of a wireless access method and an advanced wireless network (hereinafter referred to as Long Term Evolution (LTE) or Evolved Universal Terrestrial Radio Access (EUTRA)) has been established by the 3rd Generation Partnership Project (3GPP). In LTE, orthogonal frequency division multiplexing (OFDM), which is a multi-carrier transmission method, is used as a communication method for wireless communication from a base station apparatus to a mobile station apparatus (referred to as a downlink (DL)). Furthermore, in LTE, SC-FDMA (Single-Carrier Frequency Division Multiple Access), which is a single-carrier transmission method, is used as a communication method for wireless communication from a mobile station apparatus to a base station apparatus (referred to as an uplink (UL)). In LTE, a DFT-Spread OFEM (Discrete Fourier Transform-Spread OFDM) method is used as SC-FDMA.

In 3GPP, to achieve higher-speed data communication than is possible by LTE, a wireless access method and a wireless network (hereinafter referred to as Long Term Evolution-Advanced (LTE-A) or Advanced Evolved Universal Terrestrial Radio Access (A-EUTRA)) are under discussion. In LTE-A, it is required to achieve a backward compatibility with LTE. That is, it is required for LTE-A to assure that a base station apparatus based on LTE-A is capable of simultaneously communicating with both a mobile station apparatus based on LTE-A and a mobile station apparatus based on LTE and that the mobile station apparatus based on LTE-A is capable of communicating with the base station apparatus based on LTE-A and a base station apparatus based on LTE.

In LTE-A, to achieve the above requirement, it is under discussion to support at least the same channel structure as that used in LTE. The channel refers to a medium used to transmit a signal. A channel used in a physical layer is referred to as a physical channel, and a channel used in a medium access control (MAC) layer is referred to as a logical channel. The physical channel has the following types: a physical downlink shared channel (PDCCH) used to transmit/receive downlink data and control information; a physical downlink control channel (PDCCH) used to transmit/receive downlink control information; a physical uplink shared channel (PUSCH) used to transmit/receive uplink data and control information; a physical uplink control channel (PUCCH) used to transmit/receive control information; a synchronization channel (SCH) used to establish downlink synchronization; a physical random access channel (PRACH) used to establish uplink synchronization; and a physical broadcast channel (PBCH) used to transmit/receive downlink system information. A mobile station apparatus or a base station apparatus transmits control information or a signal generated from data or the like by mapping the signal in each physical channel. Data transmitted via the physical downlink shared channel or the physical uplink shared channel is referred to as a transport block.

The control information mapped to the physical uplink control channel is referred to as uplink control information (UCI). The uplink control information is one of the followings: control information (a reception confirmation response (ACK/NACK)) indicating an affirmative response (Acknowledgement (ACK)) or a negative response (Negative Acknowledgement (NACK)) issued in response to received data mapped to the physical downlink shared channel; control information (Scheduling Request (SR)) indicating a request for assignment of an uplink resource; and control information (Channel Quality Indicator (CQI)) indicating reception quality of the downlink (also referred to as channel equality).

### <Cooperative Communication>

In LTE-A, to achieve a reduction or suppression of interference with a mobile station apparatus in a cell edge area, or to increase reception signal power, it is under discussion to employ cooperative multipoint communication (CoMP communication) between adjacent cells. For example, when a base station apparatus performs communication using one arbitrary frequency band, this method is called a “cell.” One of examples of methods for the cooperative multipoint communication, which are under discussion, is to perform weighted signal processing (precoding process) on a signal such that a weighting factor is different among a plurality of cells and the signal is transmitted to the same mobile station apparatus cooperatively from a plurality of base station apparatuses (this method is also called “joint processing” or “joint transmission”). This method makes it possible to increase a signal to interference-plus-noise power ratio for the mobile station apparatus, which may result in an improvement in reception characteristic at the mobile station apparatus. For example, it is under investigation to perform cooperative multipoint communication such that a plurality of cells perform coordinated scheduling (CS) for a mobile station apparatus. This method allows an improvement in the signal to interference-plus-noise power ratio for the mobile station apparatus. For example, it is under investigation to perform cooperative multipoint communication such that in a plurality of cells, a signal is transmitted to a mobile station apparatus by using a coordinated beam forming (CB) technique. This method allows an improvement in the signal to interference-plus-noise power ratio for the mobile station apparatus. For example, in a method (blanking/muting method) that is under investigation, cooperative multipoint communication is performed such that a signal is transmitted using a particular resource only in one cell, while in other cells, the signal is not transmitted using that resource. This method allows an improvement in the signal to interference-plus-noise power ratio for the mobile station apparatus.

The plurality of cells involved in cooperative multipoint communication may be configured such that the cells respectively include different base station apparatuses, or such that the cells respectively include different RRHs (Remote Radio Heads, outdoor wireless communication units smaller in size than the base station apparatus, also referred to as Remote Radio Unis (RRUs)) managed by the same base station apparatus 3, or such that one of the cells includes a base station apparatus and the other cells respectively include RRHs managed by the base station apparatus, or such that one of the cells includes a base station apparatus and the other cells respectively include RRHs managed by another base station apparatus.

A base station apparatus that provides a large coverage is generally called a macro base station apparatus. A base station apparatus that provides a small coverage is generally called a pico base station apparatus or femto base station apparatus. In a plan that is under discussion, RRHs are generally operated in smaller coverage areas than coverage areas of macro base station apparatuses. It is known to configure a communication system so as to include a macro base station apparatus and a RRH such that the coverage supported by the macro base station apparatus includes part or all of the coverage supported by the RRH. The communication system configured in such a manner is called a heterogeneous network. In such a heterogeneous network communication system, it is under discussion to employ a communication method in which the macro base station apparatus and the RRH cooperatively transmit a signal to a mobile station apparatus located in an overlapping coverage area between the macro base station apparatus and the RRH. Note that the RRH is managed by the macro base station apparatus, and transmission and reception are controlled by the macro base station apparatus. Also note that the macro base station apparatus and the RRH are connected to each other via a wired line such as an optical fiber or the like or a wireless line using a relay technique. By performing the cooperative communication such that part or all of the macro base station apparatus and the RRHs use the same radio resource, it is possible to improve the overall frequency usage efficiency (transmission capacity) in the coverage area provided by the macro base station apparatus.

In a case where a mobile station apparatus is located close to the macro base station apparatus or the RRH, the mobile station apparatus is allowed to communicate with the macro base station apparatus or the RRH in a single cell communication mode. In this case, such a mobile station apparatus transmits/receives a signal to/from the macro base station apparatus or the RRH via communication without using the cooperative multipoint communication. For example, the macro base station apparatus may receive a signal in the uplink from a mobile station apparatus located close in distance to the macro base station apparatus. For example, the RRH may receive a signal in the uplink from a mobile station apparatus located close in distance to the RRH. In a case where a mobile station apparatus is located close to an edge (cell edge) of the coverage area supported by the RRH, it is necessary to handle cochannel interference from the macro base station apparatus. Regarding the multi-cell communication (cooperative multipoint communication) between a macro base station apparatus and a RRH, a method is under investigation to reduce or suppress the interference to a mobile station apparatus located in a cell edge area by employing the CoMP communication method in which communication is performed cooperatively between the macro base station apparatus and the RRH.

Another method is also under investigation, in which, in a downlink, a mobile station apparatus receives signals transmitted in a cooperative manner from a macro base station apparatus and an RRH, respectively, while in an uplink, the mobile station apparatus transmits a signal to either the macro base station apparatus or the RRH in a form suitable therefor. For example, the mobile station apparatus transmits a signal in the uplink with transmission power suitable for the signal to be received by the macro base station apparatus. For example, the mobile station apparatus transmits a signal in the uplink with transmission power suitable for the signal to be received by the RRH. This makes it possible to reduce unnecessary interference in the uplink thereby improving the frequency usage efficiency.

In a technique under investigation, a mobile station apparatus estimates a path loss from each of a plurality of types of reference signals, and the mobile station apparatus sets parameters associated with the transmission power to be suitable for the signal to be received by the macro base station apparatus or the RRH (NPL 1). For example, the mobile station apparatus calculates the parameters associated with transmission power based on the reference signal transmitted from the macro base station apparatus to determine the transmission power suitable for the signal to be received by the macro base station apparatus. For example, the mobile station apparatus calculates the parameters associated with transmission power based on the reference signal transmitted from the RRH to determine the transmission power suitable for the signal to be received by the RRH. For example, the mobile station apparatus calculates the parameters associated with transmission power based on the reference signal transmitted cooperatively from both the macro base station apparatus and the RRH to determine the transmission power suboptimum for the signal to be received by the macro base station apparatus or the RRH. More specifically, the mobile station apparatus estimates a path loss based on reception quality of the received reference signal.

To allow the base station apparatus to recognize how much room the mobile station apparatus has in transmission of a signal in the uplink with reference to a maximum transmission power value available in the mobile station apparatus (a maximum available transmission power value), the mobile station apparatus notifies the base station apparatus of a power headroom (PH) that is a value obtained by subtracting a transmission power value used in the transmission of the signal in the uplink from the maximum available transmission value.

The value of the power headroom is expressed in units of 1 dB in a range of −23 dB to 40 dB. When the value of the power headroom is positive, this indicates that the mobile station apparatus has a margin for the transmission power. When the value of the power headroom is negative, this indicates that although the mobile station apparatus is performing transmission with the available maximum value of transmission power, the value of transmission power requested by the base station apparatus is greater than the maximum transmission power value available at the mobile station apparatus. Using information on the power headroom, the base station apparatus adjusts or determines a frequency bandwidth of a resource to be assigned to a signal in the uplink transmitted by the mobile station apparatus, and a modulation method used for the signal in the uplink.

The mobile station apparatus controls the transmission of the power headroom using two timers (periodicPHR-Timer and prohibitPHR-Timer) and a value dl-PathlossChange (expressed in dB) notified from the base station apparatus. In a case where any one of events described below occurs, the mobile station apparatus decides to perform transmission of the power headroom. A first event is that prohibitPHR-Timer has expired and the value of the path loss has changed from the value of the path loss used in the previous transmission of the power headroom by an amount equal to or greater than dl-PathlossChange. A second event is that periodicPHR-Timer expires. A third event is that setting or resetting is performed in terms of the function of transmitting the power headroom. The process of determining whether to transmit the power headroom and reporting the power headroom to the base station apparatus is referred to as power headroom reporting.

After the mobile station apparatus decides to transmit the power headroom, when a resource used in the transmission of the signal in the uplink is assigned by the base station apparatus, the mobile station apparatus transmits the signal in the uplink together with the information associated with the power headroom to the base station apparatus. After the mobile station apparatus transmits the information associated with the power headroom, the mobile station apparatus resets periodicPHR-Timer and prohibitPHR-Timer used in measuring, and restarts them.

### CITATION LIST

### Non Patent Literature

NPL 1: “UL PC for Networks with Geographically Distributed RRHs”, 3GPP TSG RANI #66, Athens, Greece, 22-26, August, 2011, R1-112523

### SUMMARY OF INVENTION

### Technical Problem

However, in the conventional technique associated with the power headroom, only one case is assumed in which one type of path loss is estimated from one type of reference signal, and the estimated one type of path loss is used in determining transmission power for a signal in the uplink. For example, NPL 1 does not disclose a technique of controlling transmission of a power headroom using a path loss estimated based on one of a plurality of types of reference signals. For example, NPL 1 does not disclose a technique of controlling transmission of information associated with a power headroom for a case where in a mobile station apparatus estimates a plurality of types of path losses from a plurality of types of reference signals, calculates transmission power from the respective path losses, and transmits a signal in the uplink using the calculated transmission power.

In a case where information associated with the power headroom is not properly given to the base station apparatus, the base station apparatus is not capable of efficiently assigning a resource to a signal in the uplink for the mobile station apparatus and determining the modulation method, which results in degradation in accuracy of scheduling for the uplink. For example, in a communication system in which a destination of a signal (or a plurality of destinations of signals) is allowed to be switched dynamically, it is desirable, in order to achieve an improvement in frequency usage efficiency, to use a path loss suitable for each destination in determination of transmission power for a signal in the uplink, and efficiently perform scheduling for the uplink to each destination. Note that the dynamic switching is performed, for example, in units of subframes.

In view of the above, it is an object of the present invention to provide a mobile station apparatus, a communication system, a communication method, and an integrated circuit, that make it possible to efficiently transmit a signal in the uplink in a communication system including a plurality of mobile station apparatuses and a base station apparatus.

### Solution to Problem

(1) To achieve the above-described object, the present invention provides means described below. That is, the invention provides a mobile station apparatus configured to communicate with at least one base station apparatus, including a first reception processing unit configured to receive a signal from the base station apparatus in a cell, a path loss calculation unit configured to calculate a plurality of path losses based on a first reference signal and a second reference signal received by the first reception processing unit, a transmission power setting unit configured to set transmission power for a physical uplink shared channel using one of the plurality of the path losses calculated by the path loss calculation unit, a power headroom generation unit configured to generate a first power headroom and a second power headroom, the first power headroom being information associated with a margin of transmission power and produced using a band width of a resource allocated for the physical uplink shared channel and the path loss used in the setting of the transmission power for the physical uplink shared channel, the second power headroom being information associated with a margin of transmission power and produced, without depending on the band width of the resource allocated for the physical uplink shared channel, using a path loss being one of the plurality of path losses calculated by the path loss calculation unit but being not used in the setting of the transmission power for the physical uplink shared channel, and a power headroom control unit configured to control transmission, using the physical uplink shared channel, of the first power headroom and the second power headroom generated by the power headroom generation unit.

(2) In the mobile station apparatus according to the present invention, the first reference signal may be either a CRS (Cell specific Reference Signal) or a CSI-RS (Channel State Information Reference Signal), and the second reference signal may be a signal different from the first reference signal and may be either the CRS or the CSI-RS.

(3) In the mobile station apparatus according to the present invention, the first reference signal and the second reference signal may be respectively Channel State Information Reference Signals (CSI-RSs) with different configurations.

(4) In the mobile station apparatus according to the present invention, the power headroom control unit may use a common periodicPHR-Timer for both a transmission process of the power headroom using the path loss calculated based on the first reference signal and a transmission process of the power headroom using the path loss calculated based on the second reference signal, and in a case where the periodicPHR-Timer expires, the power headroom control unit may determine to transmit the power headroom using the path loss calculated based on the first reference signal and the power headroom using the path loss calculated based on the second reference signal.

(5) In the mobile station apparatus according to the present invention, the power headroom control unit may perform controlling such that when a determination is made to transmit the power headroom using the path loss calculated based on the first reference signal and the power headroom using the path loss calculated based on the second reference signal, the first power headroom and the second power headroom are transmitted using a physical uplink shared channel to which a resource is allocated first after the determination.

(6) In the mobile station apparatus according to the present invention, the power headroom control unit may use independent pieces of dl-PathlossChange for the path loss calculated based on the first reference signal and the path loss calculated based on the second reference signal, and in a case where either one of the path losses changes by an amount equal to or greater than a corresponding one of pieces of dl-PathlossChange, the power headroom control unit may determine to transmit the power headroom using the path loss calculated based on the first reference signal and the power headroom using the path loss calculated based on the second reference signal.

(7) In the mobile station apparatus according to the present invention, the power headroom control unit may perform controlling such that when a determination is made to transmit the power headroom using the path loss calculated based on the first reference signal and the power headroom using the path loss calculated based on the second reference signal, the first power headroom and the second power headroom are transmitted using a physical uplink shared channel to which a resource is allocated first after the determination.

(8) The present invention provides a communication system including a plurality of mobile station apparatuses and at least one base station apparatus configured to communicate with the plurality of mobile station apparatuses, the base station apparatus including a transmission processing unit configured to transmit a signal to the mobile station apparatuses, a second reception processing unit configured to receive a signal from the mobile station apparatuses, the mobile station apparatuses each including a first reception processing unit configured to receive a signal from the base station apparatus in a cell, a path loss calculation unit configured to calculate a plurality of path losses based on a first reference signal and a second reference signal received by the first reception processing unit, a transmission power setting unit configured to set transmission power for a physical uplink shared channel using one of the plurality of the path losses calculated by the path loss calculation unit, a power headroom generation unit configured to generate a first power headroom and a second power headroom, the first power headroom being information associated with a margin of transmission power and produced using a band width of a resource allocated for the physical uplink shared channel and the path loss used in the setting of the transmission power for the physical uplink shared channel, the second power headroom being information associated with a margin of transmission power and produced, without depending on the band width of the resource allocated for the physical uplink shared channel, using a path loss being one of the plurality of path losses calculated by the path loss calculation unit but being not used in the setting of the transmission power for the physical uplink shared channel, and a power headroom control unit configured to control transmission, using the physical uplink shared channel, of the first power headroom and the second power headroom generated by the power headroom generation unit.

(9) The present invention provides a communication method used in a mobile station apparatus configured to communicate with at least one base station apparatus, including at least the steps of, in a cell, receiving a signal from the base station apparatus, calculating a plurality of path losses based on the received first reference signal and the received second reference signal, setting transmission power for a physical uplink shared channel using one of the plurality of calculated path losses, generating a first power headroom and a second power headroom, the first power headroom being information associated with a margin of transmission power and produced using a band width of a resource allocated for the physical uplink shared channel and the path loss used in the setting of the transmission power for the physical uplink shared channel, the second power headroom being information associated with a margin of transmission power and produced, without depending on the band width of the resource allocated for the physical uplink shared channel, using a path loss being one of the plurality of path losses calculated but being not used in the setting of the transmission power for the physical uplink shared channel, and controlling transmission, using the physical uplink shared channel, of the first power headroom and the second power headroom generated by the power headroom generation unit.

(10) The present invention provides an integrated circuit disposed in a mobile station apparatus configured to communicate with at least one base station apparatus, the integrated circuit configured to implement a plurality of functions in the mobile station apparatus, the functions including a function of, in a cell, receiving a signal from the base station apparatus, a function of calculating a plurality of path losses based on the received first reference signal and the received second reference signal, a function of setting transmission power for a physical uplink shared channel using one of the plurality of calculated path losses, a function of generating a first power headroom and a second power headroom, the first power headroom being information associated with a margin of transmission power and produced using a band width of a resource allocated for the physical uplink shared channel and the path loss used in the setting of the transmission power for the physical uplink shared channel, the second power headroom being information associated with a margin of transmission power and produced, without depending on the band width of the resource allocated for the physical uplink shared channel, using a path loss being one of the plurality of path losses calculated but being not used in the setting of the transmission power for the physical uplink shared channel, and a function of controlling transmission, using the physical uplink shared channel, of the generated first power headroom and the generated second power headroom.

In the present description, the invention is disclosed in terms of improvements of the mobile station apparatus, the communication system, the communication method, and the integrated circuit for the case where information associated with the transmission power of the mobile station apparatus is notified to the base station apparatus. However, the communication method usable in the present invention is not limited to the communication methods such as LTE or LTE-A having upward compatibility with LTE. For example, the present invention may also be applied to UMTS (Universal Mobile Telecommunications System).

### Advantageous Effects of Invention

The present invention makes it possible for a base station apparatus to control a mobile station apparatus so as to efficiently transmit a signal in the uplink.

### BRIEF DESCRIPTION OF DRAWINGS

FIG. 1 is a block diagram schematically illustrating a configuration of a base station apparatus 3 according to an embodiment of the present invention.

FIG. 2 is a block diagram schematically illustrating a configuration of a transmission processing unit 107 of a base station apparatus 3 according to an embodiment of the present invention.

FIG. 3 is a block diagram schematically illustrating a configuration of a reception processing unit 101 of a base station apparatus 3 according to an embodiment of the present invention.

FIG. 4 is a block diagram schematically illustrating a configuration of a mobile station apparatus 5 according to an embodiment of the present invention.

FIG. 5 is a block diagram schematically illustrating a configuration of a reception processing unit 401 of a mobile station apparatus 5 according to an embodiment of the present invention.

FIG. 6 is a block diagram schematically illustrating a configuration of a transmission processing unit 407 of a mobile station apparatus 5 according to an embodiment of the present invention.

FIG. 7 is a flow chart illustrating an example of a process of transmitting a power headroom of a mobile station apparatus 5 according to an embodiment of the present invention.

FIG. 8 is a diagram illustrating an overview of a communication system according to an embodiment of the present invention.

FIG. 9 is a diagram schematically illustrating a structure of a time frame in a downlink from a base station apparatus 3 to a mobile station apparatus 5 according to an embodiment of the present invention.

FIG. 10 is a diagram illustrating an example of a manner in which downlink reference signals (CRS, UE-specific RS) are allocated in a downlink subframe in a communication system 1 according to an embodiment of the present invention.

FIG. 11 is a diagram illustrating an example of a manner in which downlink reference signals (CSI-RS) are mapped to a downlink subframe in a communication system 1 according to an embodiment of the present invention.

FIG. 12 is a diagram schematically illustrating a structure of a time frame in an uplink from a mobile station apparatus 5 to a base station apparatus 3 according to an embodiment of the present invention.

### DESCRIPTION OF EMBODIMENTS

A technique disclosed in the present description may be applied to a wide variety of wireless communication systems such as a code division multiple access (CDMA) system, a time division multiple access (TDMA) system, a frequency division multiple access (FDMA) system, an orthogonal FDMA (OFDMA) system, a single carrier FDMA (SC-FDMA) system, and other systems. Note that the term “system” and the “network” are often used synonymously. In the CDMA system, wireless communication techniques (standards) such as universal terrestrial radio access (UTRA) technique, a cdma2000 (registered trademark) technique, or the like may be implemented. UTRA includes improved versions such as wideband CDMA (WCDMA), CDMA, and the like. cdma2000 covers IS-2000, IS-95, and IS-856 standards. The TDMA system may include an implementation of a wireless communication technique such as Global System for Mobile Communications (GSM (registered trademark)). The OFDMA system may include an implementation of a wireless communication technique such as evolved UTRA (E-UTRA), ultra mobile broadband (UMB), IEEE802.11 (Wi-Fi), IEEE802.16 (WiMAX), IEEE802.20, Flash-OFDM (registered trademark), or the like. UTRA and E-UTRA are part of a universal mobile telecommunications system (UMTS). 3GPP LTE (Long Term Evolution) is UMTS using E-UTRA in which OFDMA is used on downlinks and SC-FDMA is used on uplinks. LTE-A is an improved version of LTE for a system, a wireless communication technique, and standards. UTRA, E-UTRA, UMTS, LTE, LTE-A, and GSM (registered trademark) are described in documents issued by an institution called Third Generation Partnership Project (3GPP). cdma2000 and UMB are described in documents issued by an institution called Third Generation Partnership Project 2 (3GPP2). To provide clearness, data communication in LTE or LTE-A in an aspect of this technique will be described later, and technical terms associated with LTE or LTE-A will be used in the following description.

### First Embodiment

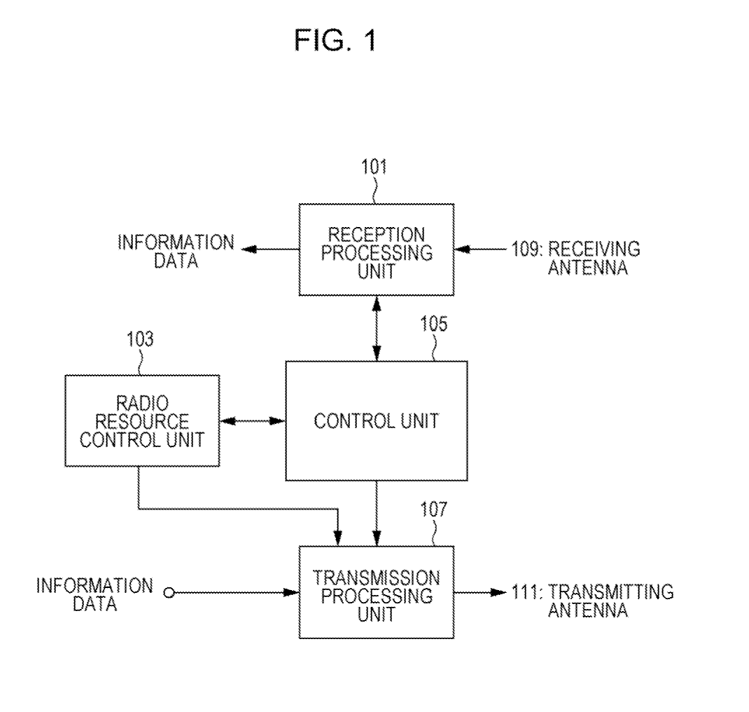

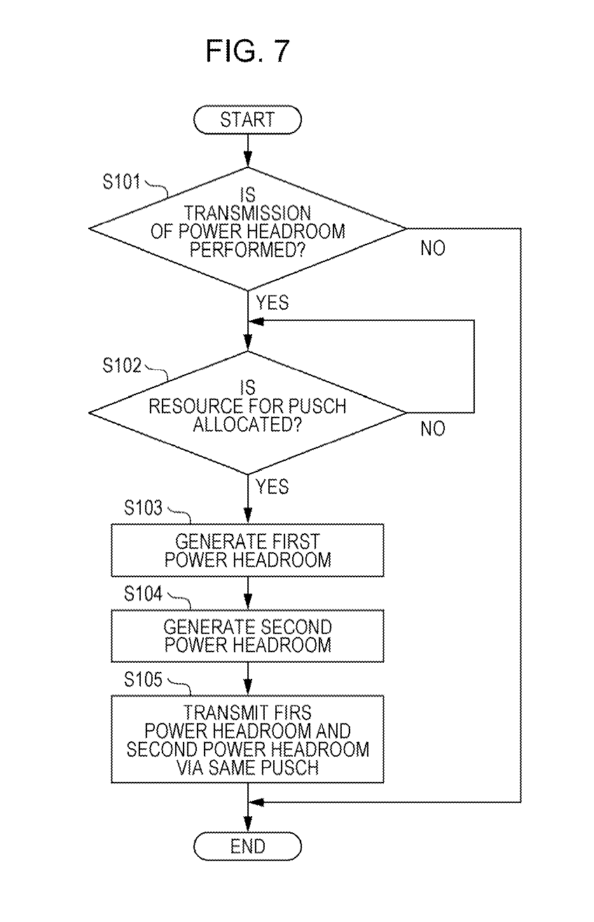

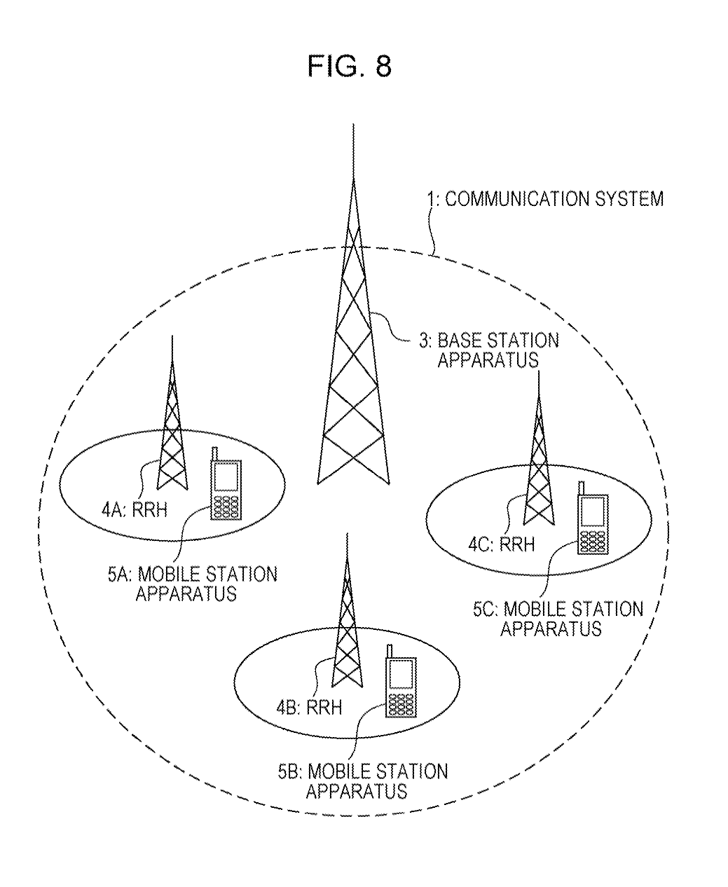

A first embodiment of the present invention is described in detail below with reference to drawings. First, referring to FIG. 8 to FIG. 12, an overview of a communication system according to the present embodiment is given, and a configuration of a radio frame is discussed. Next, referring to FIG. 1 to FIG. 6, a configuration of the communication system according to the present embodiment is described. Thereafter, referring to FIG. 7, an operation and processing associated with the communication system according to the present embodiment are described.

### <Overview of Communication System>

FIG. 8 is a diagram illustrating an overview of a communication system according to an embodiment of the present invention. In the communication system 1 illustrated in this figure, communication is performed among a base station apparatus (also referred to as eNodeB, NodeB, BS (Base Station), AP (Access Point), or macro base station) 3, a plurality of RRHs (Remote Radio Heads, which are apparatuses being smaller in size than the base station apparatus and including an outdoor wireless communication unit, and which are also referred to as Remote Radio Unis (RRUs)) (also referred to as a remote antenna or distributed antenna) 4A, 4B, and 4C, and a plurality of mobile station apparatuses (also referred to as UE (User Equipment), MS (Mobile Station), MT (Mobile Terminal), terminal, terminal apparatus, or mobile terminal) 5A, 5B, and 5C. Hereinafter, in the description of the present embodiment, RRHs 4A, 4B, and 4C are generically referred to as RRH(s) 4, and mobile station apparatuses 5A, 5B, and 5C are generically referred to as mobile station apparatus(es) 5. In the communication system 1, the base station apparatus 3 and a RRH 4 cooperatively communicate with a mobile station apparatus 5. In the example illustrated in FIG. 8, the base station apparatus 3 and the RRH 4A cooperatively communicate with the mobile station apparatus 5A, the base station apparatus 3 and the RRH 4B cooperatively communicate with the mobile station apparatus 5B, and the base station apparatus 3 and the RRH 4C cooperatively communicate with the mobile station apparatus 5C. Furthermore, in the communication system 1, a plurality of RRHs 4 cooperatively communicate with the mobile station apparatus 5. For example, the RRH 4A and the RRH 4B cooperatively communicate with the mobile station apparatus 5A or mobile station apparatus 5B, the RRH 4B and the RRH 4C cooperatively communicate with the mobile station apparatus 5B or mobile station apparatus 5C, and the RRH 4C and the RRH 4A cooperatively communicate with the mobile station apparatus 5C or mobile station apparatus 5A.

Note that the RRH may be said to be a base station apparatus configured in a special form. For example, the RRH may be regarded as such a base station apparatus that it includes only a signal processing unit, and setting of parameters used in the RRH and determination of scheduling are performed by another base station apparatus. Therefore, in the following description, the term base station apparatus 3 is used to generically describe base station apparatuses including RRH 4s.

### <Cooperative Multipoint Communication>

In the communication system 1 according to the present embodiment, cooperative multipoint (CoMP) communication may be employed to transmit/receive signal cooperatively using a plurality of cells. Note that, for example, when a base station apparatus performs communication using one arbitrary frequency band, this method is called a “cell.” For example, cooperative multipoint communication may be performed such that a plurality of cells (the base station apparatus 3 and the RRH 4) perform different weighted signal processing (precoding processes) on a signal, and the base station apparatus 3 and the RRH 4 cooperatively transmit the signal to the same mobile station apparatus 5. For example, cooperative multipoint communication may be performed such that a plurality of cells (the base station apparatus 3 and RRH 4) cooperatively perform scheduling (coordinated scheduling (CS)) for the mobile station apparatus 5. For example, cooperative multipoint communication may be performed such that a plurality of cells (the base station apparatus 3 and RRH 4) cooperatively perform beam forming (coordinated beam forming (CB)) and transmit a signal to the mobile station apparatus 5. For example, cooperative multipoint communication may be performed such that only in one cell (the base station apparatus 3 or the RRH 4), a signal is transmitted using a particular resource, but in the other cell (the base station apparatus 3 or the RRH 4), transmission of the signal using that resource is not performed (blanking, muting).

In the present embodiment, although a detailed description is omitted, a plurality of cells that perform cooperative multipoint communication may be configured such that the cells respectively include different base station apparatuses 3 or such that the cells respectively include different RRHs 4 managed by the same base station apparatus 3, or such that one of the cells includes a base station apparatus 3 and the other cells respectively include RRHs 4 managed by another base station apparatus 3.

Note that although a plurality of cells are physically different cells, they may be used as logically the same cell. More specifically, in this case, a common cell identifier (physical cell ID) may be applied to cells. When a plurality of transmitting apparatuses (the base station apparatus 3 and the RRH 4) transmit the same signal to the same receiving apparatus using the same frequency, this configuration is called a single frequency network (SFN).

In the present embodiment of the invention, it is assumed that the communication system 1 is configured in the form of a heterogeneous network. The communication system 1 includes the base station apparatus 3 and the RRHs 4 and is configured such that a coverage supported by the base station apparatus 3 includes part or all of a coverage supported by each RRH 4. Note that the coverage refers to an area in which requested communication is possible. In the communication system 1, the base station apparatus 3 and the RRH 4 cooperatively transmit a signal to a mobile station apparatus 5 located in an overlapping coverage area of the base station apparatus 3 and the RRH 4. Note that each RRH 4 is managed by the base station apparatus 3, and transmission and reception is controlled by the base station apparatus 3. Note that the base station apparatus 3 and the RRHs are connected to each other via a wired line such as an optical fiber or the like or a wireless line using a relay technique.

In a case where a mobile station apparatus 5 is located close to the base station apparatus 3 or a RRH 4, the mobile station apparatus 5 may communicate with the base station apparatus 3 or the RRH 4 in a single cell communication mode. In this case, such a mobile station apparatus 5 may transmit/receive a signal to/from the base station apparatus 3 or the RRH 4 via communication without using the cooperative multipoint communication. More specifically, for example, the base station apparatus 3 may receive a signal in the uplink from a mobile station apparatus 5 located close in distance to the base station apparatus 3. For example, a RRH 4 may receive a signal in the uplink from the mobile station apparatus 5 located close in distance to the RRH 4. For example, both the base station apparatus 3 and a RRH 4 may receive a signal in the uplink from a mobile station apparatus 5 located close to an edge (cell edge) of a coverage supported by the RRH 4. For example, a plurality of RRHs 4 may receive a signal in the uplink from a mobile station apparatus 5 located close to an edge (cell edge) of a coverage supported by each RRH 4.

Alternatively, in the downlink, a mobile station apparatus 5 may mobile station apparatus 5 may receive a signal transmitted from both the base station apparatus 3 and a RRH 4 using cooperative multipoint communication, while in the uplink, the mobile station apparatus 5 may transmit a signal to either the base station apparatus 3 or the RRH 4 in a form suitable therefor. For example, the mobile station apparatus 5 transmits a signal in the uplink with transmission power suitable for the signal to be received by the base station apparatus 3. For example, the mobile station apparatus 5 transmits a signal in the uplink with transmission power suitable for the signal to be received by the RRH 4.

In the communication system 1, the downlink (DL) used in communication in a direction from the base station apparatus 3 or the RRH 4 to the mobile station apparatus 5 includes a downlink pilot channel a physical downlink control channel (PDCCH), and a physical downlink shared channel (PDSCH). In the PDSCH, the cooperative multipoint communication may or may not be employed.

Furthermore, in the communication system 1, the uplink (UL) used in communication in a direction from the mobile station apparatus 5 to the base station apparatus 3 or the RRH 4 includes a physical uplink shared channel (PUSCH), an uplink pilot channel (uplink reference signal (UL RS), sounding reference signal (SRS), demodulation reference signal (DM RS)), and a physical uplink control channel (PUCCH). The channel refers to a medium used to transmit a signal. A channel used in a physical layer is called a physical channel, a channel used in a medium access control (MAC) layer is called a logical channel.

The present invention may be applied to such a communication system that is controlled such that in the uplink, the mobile station apparatus 5 transmits a signal to the base station apparatus 3 with transmission power suitable for the signal to be received by the base station apparatus 3 and the mobile station apparatus 5 transmits a signal to the RRH 4 with transmission power suitable for the signal to be received by the RRH 4. For simplicity of explanation, descriptions of some operations other than the above will be omitted. Note that the omission is merely for simplicity of explanation but not for limiting the invention only to the operations described. For example, the present invention may also be applicable to a communication system that is controlled such that in the uplink, the mobile station apparatus 5 transmits a signal with transmission power optimum for the signal to be received by the RRH 4 and the mobile station apparatus 5 transmits the signal with transmission power suboptimum for the signal to be received by the base station apparatus 3.

Furthermore, embodiments of the present invention are not limited to the communication system 1 in which only channels described herein are used, but the embodiments of the present invention may also be applicable to a communication system in which another channel is used. For example, a downlink control channel such as enhanced-PDCCH (E-PDCCH) having a characteristic different from that of PDCCH may be used independently of PDCCH. For example, E-PDCCH may be subjected to a precoding process. For example, E-PDCCH may be subjected to a demodulation process such as a channel compensation process based on a reference signal subjected to a process similar to the precoding process applied to E-PDCCH.

PDSCH is a physical channel used to transmit/receive downlink data and control information. PDCCH is a physical channel used to receive/transmit downlink control information. PUSCH is a physical channel used to transmit/receive uplink data and control information. PUCCH is a physical channel used to transmit/receive uplink control information (UCI). UCI has the following types: a reception confirmation response (ACK/NACK)) indicating an affirmative response (Acknowledgement (ACK)) or a negative response (Negative Acknowledgement (NACK)) issued in response to data in downlink of PDSCH; and a scheduling request (SR) indicating whether assignment of a resource is requested or not. Other types of physical channels used are a synchronization channel (SCH, or a synchronization signal) used to establish downlink synchronization, a physical random access channel (PRACH) used to establish uplink synchronization, and a physical broadcast channel (PBCH) used to transmit downlink system information (SIB, also referred to as a system information block). Note that PDSCH is also used to transmit downlink system information.

The mobile station apparatus 5, the base station apparatus 3, or the RRH 4 maps control information and a signal generated from data or the like to corresponding physical channels and transmits them. Data transmitted via PDSCH or PUSCH is referred to as a transport block. An area managed by the base station apparatus 3 or the RRH 4 is referred to as a cell.

### <Structure of Downlink Time Frame>

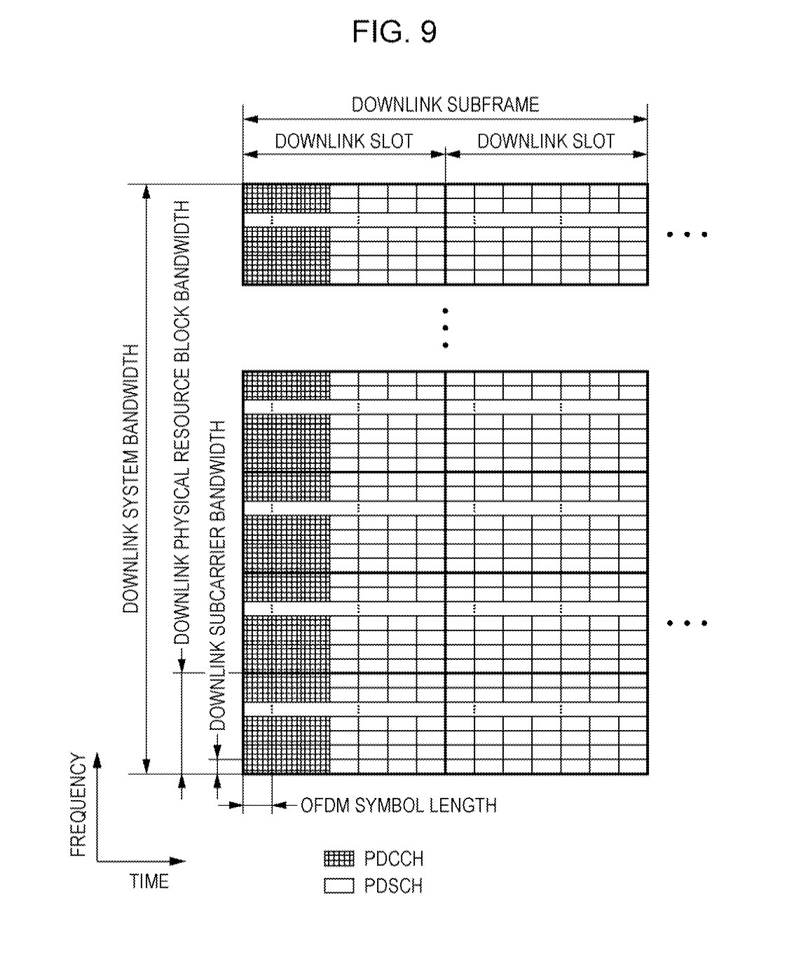

FIG. 9 is a diagram schematically illustrating a structure of a time frame of a downlink from the base station apparatus 3 or the RRH 4 to the mobile station apparatus 5 according to an embodiment of the present invention. In this figure, a horizontal axis represents a time domain, and a vertical axis represents a frequency domain. Each downlink time frame includes a pair of resource blocks (RBs) (also called physical resource blocks (RPBs)). The resource blocks are units used to allocate resources, and each resource block has a frequency band and a time band each having a particular width predetermined for the downlink. The pair of resource blocks (RBs) is referred to as a physical resource block pair (PRB pair). One downlink PRB pair (downlink physical resource block pair (DL PRB pair) includes two PRBs located contiguously in the downlink (each referred to as a downlink physical resource block (DL PRB))

In this figure, one DL PRB includes 12 subcarriers in the downlink frequency domain (each referred to as a downlink subcarrier) and 7 OFDM (orthogonal frequency division multiplexing) symbols in the time domain. A system band in the downlink (referred to as a downlink system band) is a downlink communication band for the base station apparatus 3 or the RRH 4. For example, the system bandwidth in the downlink (referred to as a downlink system bandwidth) has a frequency bandwidth of 20 MHz.

In the downlink system band, a plurality of DL PRBs are allocated depending on the downlink system bandwidth. For example, in the downlink system band having a frequency bandwidth of 20 MHz, 110 DL PRBs are allocated.

In the time domain, as illustrated in the figure, there are slots each including seven OFDM symbols (these slots are referred to as downlink slots) and subframes each including two downlink slots (these subframes are referred to as downlink subframes). A unit including one downlink subcarrier and one OFDM symbol is referred to as a resource element (RE) (downlink resource element). In each downlink subframe, at least PDSCH used to transmit information data (also referred to as a transport block) and PDCCH used to transmit control information are allocated. In this figure, PDCCH includes 1st to 3rd OFDM symbols in each downlink subframe, and PDSCH includes 4th to 14th OFDM symbols in each downlink subframe. Note that the number of OFDM symbols included in PDCCH and the number of OFDM symbols included in PDSCH may be changed from one downlink subframe to another.

Although not illustrated in the figure, downlink pilot channels used to transmit a reference signal (RS) in the downlink (also referred to as downlink reference signal) are allocated over a plurality of downlink resource elements. Note that the downlink reference signal includes at least different three types of reference signals, that is, a first type of reference signal, a second type of reference signal, and a third type of reference signal. For example, the downlink reference signal is used to estimate a change in a channel of PDSCH and PDCCH. For example, the first type of reference signal is used to demodulate PDSCH and PDCCH, and the first type of reference signal is also referred to as Cell specific RS (CRS). For example, the second type of reference signal is used only to estimate the change in channel, and is also referred to as channel state information RS (CSI-RS). For example, the third type of reference signal is used to demodulate PDSCH in the cooperative multipoint communication mode, and is also referred to as UE specific RS. The downlink reference signal is a signal known in the communication system 1. Note that the number of downlink resource elements of the downlink reference signal may be dependent on the number of transmitting antennas (antenna ports) used in communication by the base station apparatus 3 or the RRH 4 to the mobile station apparatus 5. In the following description, it is assumed that CRS used as the first type of reference signal, CSI-RS is used as the second type of reference signal, and UE specific RS is used as the third type of reference signal. Note that UE specific RS may also be used to demodulate PDSCH in the non-cooperative multipoint communication mode.

In PDCCH, the following information or signals are allocated: information representing assignment of DL PRB to PDSCH; information representing assignment of UL PRB to PUSCH; a mobile station identifier (referred to as Radio Network Temporary Identifier (RNTI); and signals generated from control information indicating, for example, a modulation method, an encoding ratio, a retransmission parameter, a spatial multiplexing order, a precoding matrix, and a transmission power control command (TP command). The control information included in PDCCH is referred to as downlink control information (DCI). DCI including information representing assignment of DL PRB to PDSCH is referred to as downlink assignment (DL assignment (also referred to as downlink grant), and DCI including information representing assignment of UL PRB to PUSCH is referred to as uplink grant (UL grant). Note that the downlink assignment includes a transmission power control command for PUCCH. Note that the uplink assignment includes a transmission power control command for PUSCH. Note that one PDCCH includes only information representing resource assignment to one PDSCH or information representing resource assignment to one PUSCH, and does not include information representing resource assignment to a plurality of PDSCHs or information representing resource assignment to a plurality of PUSCHs.

The information transmitted via PDCCH includes a cyclic redundancy check (CRC) code. Relationships among DCI, RNTI, and CRC transmitted via PDCCH are described in detail below. A CRC code is generated from DCI using a predetermined generator polynomial. The generated CRC code is subjected to an exclusive OR operation (also referred to as scrambling) using RNTI. A bit representing DCI and a bit generated by performing an exclusive OR operation on the CRC code using RNTI are modulated, and a resultant modulation signal is actually transmitted via PDCCH.

Resources for PDSCH are allocated, in time domain, in the same downlink subframe as that in which resources are allocated for PDCCH including downlink assignment used to assign the resources for the PDSCH.

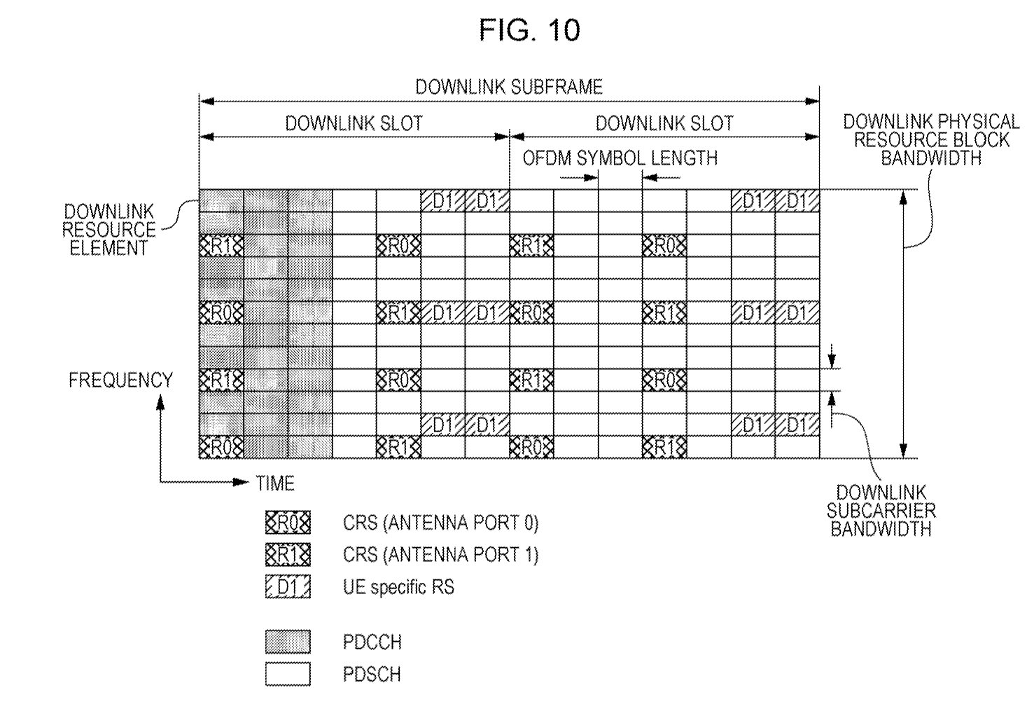

Allocation of downlink reference signals is described. FIG. 10 is a diagram illustrating an example of a manner in which downlink reference signals (CSI-RS) are allocated in a downlink subframe in the communication system 1 according to an embodiment of the present invention. In FIG. 10, for simplicity of explanation, allocation is illustrated only for downlink reference signals in one PRB pair, but allocation is performed in a similar manner over all PRB pairs in the downlink system band.

Among hatched downlink resource elements, R0 to R1 denote CRSs of respective antenna ports 0 to 1. The antenna port refers to a logical antenna used in signal processing, and one antenna port may include a plurality of physical antennas. A plurality of physical antennas of the same antenna port transmit the same signal. It is possible to achieve delay diversity or CDD (Cyclic DeLay Diversity) using a plurality of physical antennas at the same antenna port, but it is not allowed to perform other types of signal processing using a plurality of physical antennas. FIG. 10 illustrates a case where CRS is associated with two antenna ports. However, in the communication system according to the present embodiment, the number of antenna ports is not limited to two, but, for example, CRS associated with one antenna port or four antenna ports may be mapped to a downlink resource. CRS is allocated over all DL PRBs in the downlink system band.

Each hatched downlink resource element D1 denotes UE specific RS. In a case where UE specific RS is transmitted using a plurality of antenna ports, different codes are used for the antenna ports. That is, CDM (Code Division Multiplexing) is applied to UE specific RS. In this case, for the UE specific RS, the length of code used in CDM or the number of downlink resource elements to which UE specific RS is mapped may be changed depending on the control signal mapped to the PRB pair or the type of the signal processing performed on the data signal (the number of antenna ports). For example, in a case where, in the base station apparatus 3 or the RRH 4, two antenna ports are used in cooperative multipoint communication, UE specific RSs are multiplexed and allocated using codes with a code length of 2 in units of two downlink resource elements contiguous in the time domain (OFDM symbols) in the same frequency domain (subcarriers). In other words, in this case, UE specific RSs are multiplexed using CDM. For example, in a case where, in the base station apparatus 3 or the RRH 4, four antenna ports are used in cooperative multipoint communication, the number of downlink resource elements to which UE specific RSs are mapped is increased by a factor of two, and UE specific RSs are multiplexed and allocated in downlink resource elements different for each two antenna ports. In other words, in this case, UE specific RSs are multiplexed using CDM and FDM (Frequency Division Multiplexing). For example, in a case where, in the base station apparatus 3 or the RRH 4, eight antenna ports are used in cooperative multipoint communication, the number of downlink resource elements to which UE specific RSs are mapped is increased by a factor of two, and UE specific RSs are multiplexed and allocated using code with a length of 4 in units of four downlink resource elements. In other words, in this case, UE specific RSs are multiplexed using CDM with different code lengths.

Furthermore, scrambling code is superimposed on code of UE specific RS for each antenna port. The scrambling code is generated based on a cell ID and a scrambling code ID notified from the base station apparatus 3 or the RRH 4. More specifically, for example, the scrambling code is generated from a pseudo random sequence generated based on the cell ID and the scrambling code ID notified from the base station apparatus 3 or the RRH 4. For example, the scrambling code ID has a value of 0 or 1. The scrambling code ID and the antenna port used may be subjected to joint coding to represent the information by an index. UE specific RS is allocated in a DL PRB in PDSCH assigned to the mobile station apparatus 5 that is set to use UE specific RS.

The base station apparatus 3 and the RRH 4 may allocate CRS signals to different downlink resource elements or the same downlink resource elements. For example, in a case where the base station apparatus 3 and the RRH 4 allocate CRS signals to different resource elements and/or different signal sequences, the mobile station apparatus 5 is capable of calculating, using CRS, the reception power (reception signal power, reception quality) individually for the base station apparatus 3 and the RRH 4. In a particular case where the cell IDs notified from the base station apparatus 3 and the RRH 4 are different from each other, the setting may be made in the above-described manner. In another example, only the base station apparatus 3 allocates a CRS signal in part of downlink resource elements, and the RRH 4 does not allocate a CRS signal in any downlink resource element. In this case, the mobile station apparatus 5 is capable of calculating the reception power of the base station apparatus 3 based on the CRS. In a particular case where the cell ID is notified from only the base station apparatus 3, the setting may be made in the above-described manner. In another example, the base station apparatus 3 and the RRH 4 dispose CRS signals in the same downlink resource element, and the same sequence is transmitted from the base station apparatus 3 and the RRH 4. In this case, the mobile station apparatus 5 is capable of calculating the total reception power using the CRS signals. In a particular case where the cell IDs notified from the base station apparatus 3 and the RRH 4 are identical, the setting may be made in the above-described manner.

Note that in the description of the embodiments of the present invention, for example, determining electric power includes determining a value of electric power, calculating electric power includes calculating a value of electric power, measuring electric power includes measuring a value of electric power, and reporting electric power includes reporting a value of electric power. That is, the term electric power is also used to express a value of electric power.

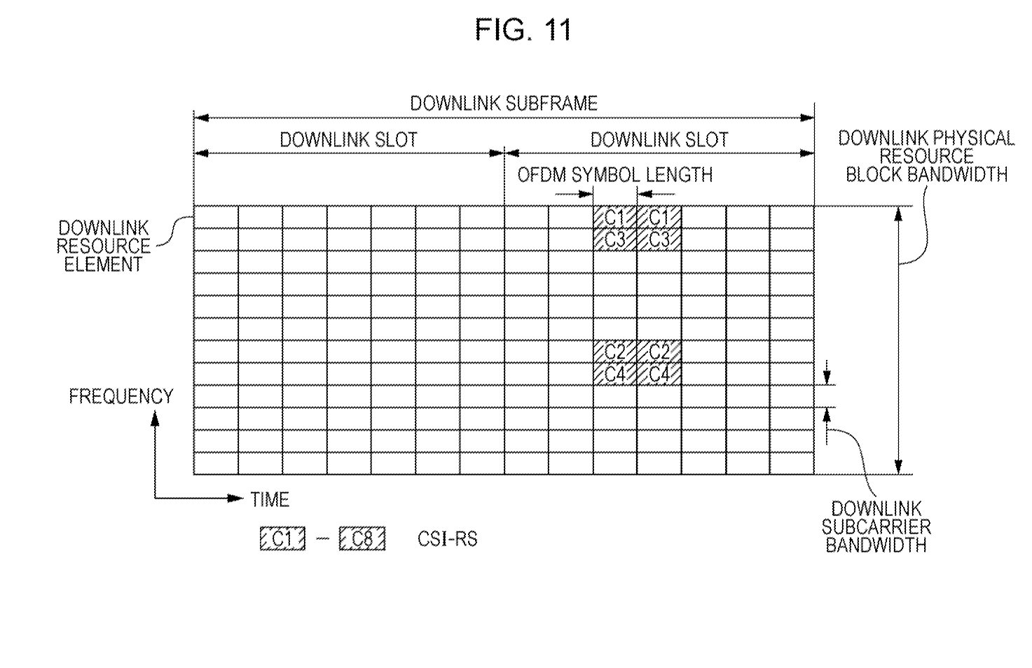

FIG. 11 is a diagram illustrating DL PRB pairs to which CSI-RSs (channel state information RSs) for eight antenna ports are mapped. That is, FIG. 11 illustrates a manner in which CSI-RSs are mapped for a case where eight antenna ports (CSI ports) are used by the base station apparatus 3 or the RRH 4. Note that in FIG. 11, for simplicity, CRS, UE specific RS, PDCCH, PDSCH and the like are not illustrated.

CSI-RSs are multiplexed such that 2-chip orthogonal code (Walsh code) is used in each CDM group, a CSI port (CSI-RS port (antenna port, resource grid)) is assigned to each orthogonal code, and code division multiplexing is performed for every 2 CSI ports. Furthermore, the respective CDM groups are frequency-division multiplexed. Using four CDM groups, CSI-RSs for 8 antenna ports of CSI ports 1 to 8 (antenna ports 15 to 22) are mapped. For example, in a CDM group 01 of CSI-RS, CSI-RSs of the CSI ports 1 and 2 (antenna ports 15 and 16) are code division multiplexed and mapped. In a CDM group C2 of CSI-RS, CSI-RSs of the CSI ports 3 and 4 (antenna ports 17 and 18) are code division multiplexed and mapped. In a CDM group C3 of CSI-RS, CSI-RSs of the CSI ports 5 and 6 (antenna ports 19 and 20) are code division multiplexed and mapped. In a CDM group C4 of CSI-RS, CSI-RSs of the CSI ports 7 and 8 (antenna ports 21 and 22) are code division multiplexed and mapped.

In a case where the base station apparatus 3 and the RRH 4 each have 8 antenna ports, the base station apparatus 3 and the RRH 4 may assign up to 8 layers (ranks, spatial multiplexing order) to PDSCH, and the base station apparatus 3 and the RRH 4 are allowed to transmit CSI-RSs identical to those used in a case where the number of antenna ports is 1, 2, or 4. The base station apparatus 3 and RRH 4 can transmit CSI-RS for one antenna port or two antenna ports by using a CDM group C1 of CSI-RS illustrated in FIG. 11. The base station apparatus 3 and RRH 4 can transmit CSI-RS for four antenna ports by using CDM groups C1 and C2 of CSI-RS illustrated in FIG. 11.

The base station apparatus 3 and the RRH 4 may allocate CSI-RS signals to different downlink resource elements or the same downlink resource elements. For example, in a case where the base station apparatus 3 and the RRH 4 allocate different downlink resource elements and/or different signal sequences to CSI-RS, the mobile station apparatus 5 is capable of calculating, using the CSI-RS, the reception power (reception signal power, reception quality) and the channel state individually for the base station apparatus 3 and the RRH 4. In the mobile station apparatus 5, the CSI-RS transmitted from the base station apparatus 3 and the CSI-RS transmitted from the RRH 4 are recognized as CSI-RSs corresponding to different antenna ports. In this case, in the mobile station apparatus 5, it is instructed by the base station apparatus 3 only to individually measure and calculate the reception power of CSI-RS corresponding to respective antenna ports, and it is not necessary to explicitly recognize whether each CSI-RS is actually transmitted from the base station apparatus 3 or the RRH 4. In another example, in a case where the base station apparatus and the RRH 4 allocate the same downlink resource element to CSI-RS and transmit the same sequence from the base station apparatus 3 and the RRH 4, the mobile station apparatus 5 is capable of calculating the total reception power using the CSI-RS. There is a possibility that different RRHs 4 allocate CSI-RS signals to different downlink resource elements. For example, in a case where different RRHs 4 allocate different downlink resource elements and/or different signal sequences to CSI-RSs, the mobile station apparatus 5 is capable of calculating, using the CSI-RS, the reception power (reception signal power, reception quality) and the channel state individually for the respective RRHs 4.

The configuration of CSI-RS (CSI-RS-Config-r10) is notified to the mobile station apparatus 5 from the base station apparatus 3 or the RRH 4. The configuration of CSI-RS includes at least information (antennaPortsCount-r10) representing the number of antenna ports set to the CSI-RS, information (subframeConfig-r10) representing a downlink subframe to which the CSI-RS is mapped, and information (ResourceConfig-r10) representing a frequency domain to which the CSI-RS is mapped. The number of antenna ports is set to, for example, one of 1, 2, 4, and 8. As information representing the frequency domain to which the CSI-RS is mapped, an index is used that indicates the location of a first resource element of resource elements to which CSI-RS corresponding to an antenna port 15 (CSI port 1) is mapped. When the location of the CSI-RS corresponding to the antenna port 15 is determined, CSI-RSs corresponding to the other antenna ports are uniquely determined based on a predetermined rule. As information representing the downlink subframe to which the CSI-RS is mapped, an index is given that indicates locations and the period of downlink subframes to which CSI-RS is mapped. For example, when the index of the subframeConfig-r10 is 5, then this indicates that one CSI-RS is mapped every 10 subframes. In this case, in radio frames configured in units of 10 subframes, CSI-RS is mapped to a subframe 0 (subframe number in radio frames). In another example, for example, in a case where the index of the subframeConfig-r10 is 1, then this indicates that one CSI-RS is mapped every 5 subframes. In this case, in radio frames configured in units of 10 subframes, CSI-RSs are mapped to subframes 1 and 6.

In the embodiment of the present invention, the description is given mainly for a case in which CSI-RS corresponding to at least a particular antenna port is transmitted only by the RRH 4. Note that this includes a case in which CSI-RS corresponding to all antenna ports of CSI-RS is transmitted only by the RRH 4. In a case where CSI-RS corresponding to part of antenna ports is transmitted only by the RRH 4, CSI-RS corresponding to other antenna ports may be transmitted only by the base station apparatus 3 or by both the base station apparatus 3 and the RRH 4 (via SFN transmission). CRS may be transmitted only by the base station apparatus 3 or by both the base station apparatus 3 and the RRH 4 (via SFN transmission).

As will be described in detail later, the mobile station apparatus 5 receives the CSI-RS for the particular antenna port transmitted only by the RRH 4, and uses the received CSI-RS to measure the path loss for the RRH 4 and set the transmission power of a signal via the uplink based on the measured path loss. This allows it to set the transmission power to be suitable for the case where the destination of the signal is the RRH 4. Alternatively, the mobile station apparatus 5 may receive the RS (CRS or CSI-RS) transmitted only by the base station apparatus 3 and may use the received RS to measure the path loss for the base station apparatus 3 and set the transmission power of a signal in the uplink based on the measured path loss. This allows it to set the transmission power to be suitable for the case where the destination of the signal is the base station apparatus 3. Alternatively, the mobile station apparatus 5 may receive RSs (CRSs or CSI-RSs) transmitted by both the base station apparatus 3 and the RRH 4 and may measure the path loss based on a combined signal and set the transmission power of a signal via the uplink using the measured path loss. This makes it possible to set the transmission power so as to be optimum to a certain degree for a case where the destination of the signal is base station apparatus 3 or the RRH 4. By setting the transmission power to be optimum for the destination of the signal in the above-described manner, it becomes possible to suppress interference of the signal to other signals and improve the efficiency of the communication system while satisfying the required signal quality. The embodiment of the present invention is supposed to be mainly applied to a communication system in which, as described above, the mobile station apparatus 5 measures a plurality of path losses from different types of downlink reference signals and controls the transmission power of the uplink signal using one of path losses or using each path loss. For example, the embodiment of the present invention is supposed to be mainly applied to a communication system in which the mobile station apparatus 5 measures a plurality of path losses from CRS and CSI-RS and controls the transmission power of the signal in the uplink using one of the path losses. Alternatively, the embodiment of the present invention is supposed to be mainly applied to a communication system in which, as described above, the mobile station apparatus 5 measures a plurality of path losses for downlink reference signals that are of the same type but transmitted from different transmitting apparatuses (base station apparatuses 3 or RRHs 4), and sets the transmission power of a signal in the uplink using one of path losses or using each path loss. For example, the mobile station apparatus 5 measures a plurality of path losses from CSI-RS corresponding to a certain antenna port and CSI-RS corresponding to a different antenna port, and controls the transmission power of the signal in the uplink using one of the path losses.

Note that information associated with the antenna port of the CSI-RS transmitted only by the RRH 4 is notified to the mobile station apparatus 5. Based on the notified information, the mobile station apparatus 5 is capable of measuring the path loss for the signal transmitted from the RRH 4. In the following, for simplicity of description, the description is given for a case where CRS is basically transmitted only by the base station apparatus 3, and CSI-RS is transmitted only by the RRH 4. Therefore, in the following description, the path loss measured based on the CRS is for the signal transmitted by the base station apparatus 3, and the path loss measured based on the CSI-RS is for the signal transmitted by the RRH 4. Note that the embodiment of the present invention is described for such a communication system only for simplicity of description but not for limitation. That is, the present invention is also applicable to other communication systems such as a communication system in which CRSs are transmitted by both the base station apparatus 3 and the RRH 4, a communication system in which only CSI-RS for a particular antenna port is transmitted by the RRH 4.

Information associated with the transmission power of CRS and the transmission power of CSI-RS is notified to the mobile station apparatus 5 from the base station apparatus 3 and the RRH 4 by using RRC signaling. As described in further detail later, the mobile station apparatus 5 measures (calculates) path losses from various types of downlink reference signals using notified transmission power of the various types of downlink reference signals.

### <Structure of Uplink Time Frame>

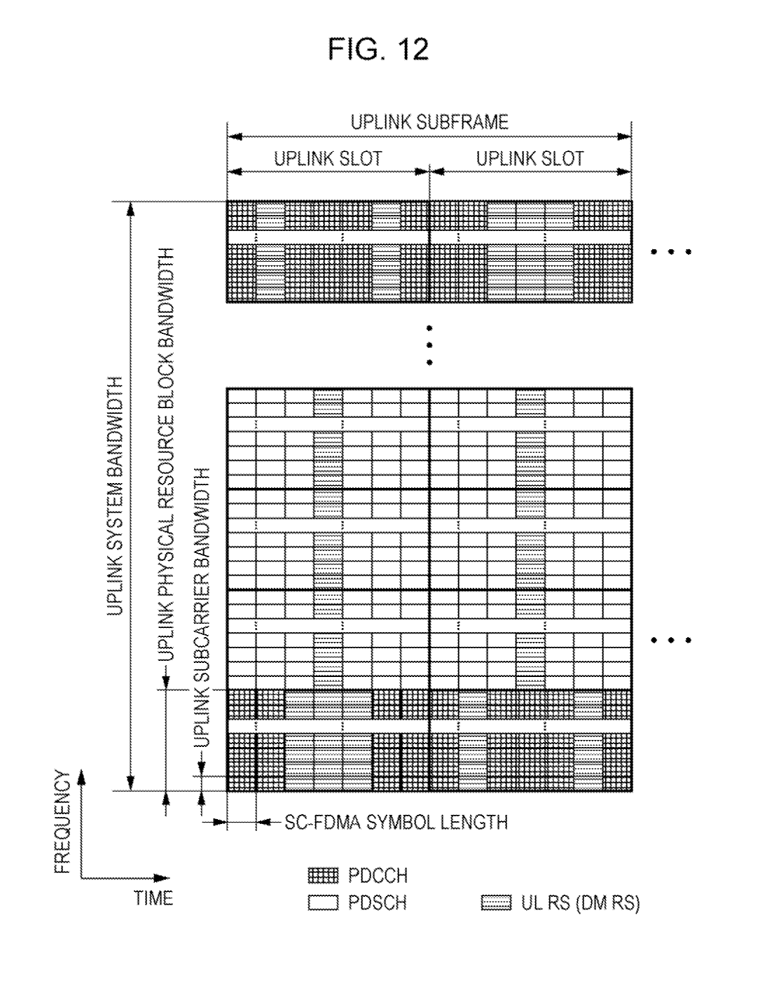

FIG. 12 is a diagram schematically illustrating a structure of a time frame of an uplink from a mobile station apparatus 5 to the base station apparatus 3 or the RRH 4 according to the embodiment of the present invention. In this figure, a horizontal axis represents a time domain, and a vertical axis represents a frequency domain. Each uplink time frame includes a pair of physical resource blocks (referred to as an uplink physical resource block pair (UL PRB pair)) that is a unit used, for example, in allocating resources and that includes frequency bands and time bands with predetermined widths in the uplink. One UL PRB pair includes two PRBs contiguous in the time domain of the uplink (referred to as uplink physical resource blocks (UL PRBs)).

In this figure, one UL PRB includes 12 subcarriers in the uplink frequency domain (each referred to as an uplink subcarrier) and 7 SC-FDMA (Single-Carrier Frequency Division Multiple Access) symbols in the time domain. A system band of the uplink (referred to as an uplink system band) is an uplink communication band for the base station apparatus 3 and the RRH 4. A system bandwidth of the uplink (referred to as an uplink system bandwidth) is a frequency bandwidth of, for example, 20 MHz.

Note that in the uplink system band, a plurality of UL PRBs are allocated depending on the uplink system bandwidth. For example, the uplink system band with the frequency bandwidth of 20 MHz includes 110 UL PRBs. Furthermore, in the time domain illustrated in this figure, there are slots each including 7 SC-FDMA symbols (each slot is referred to as an uplink slot and there are subframes each including 2 uplink slots (each subframe is referred to as an uplink subframe). A unit including one uplink subcarrier and one SC-FDMA symbol is referred to as a resource element (uplink resource element).

Each uplink subframe is allocated at least PUSCH for transmission of information data, PUCCH for transmission of uplink control information (UCI), and UL RS (DM RS) for demodulation of PUSCH and PUCCH (for estimation of change in channel). Although not illustrated in the figure, PRACH for establishment of uplink synchronization is allocated in one of uplink subframes. Furthermore, although not illustrated in the figure, UL RS (SRS) for measuring channel quality, synchronization error, and the like is allocated in one of uplink subframes. PUCCH is used to transmit UCI (ACK/NACK) indicating an acknowledgement (ACK) or a negative acknowledgment in response to data received using PDSCH, UCI (SR (Scheduling Request)) indicating at least whether or not to request an allocation of an uplink resource, and UCI (CQI (Channel Quality Indicator)) indicating reception quality (also referred to as channel quality) of the downlink.

In a case where the mobile station apparatus 5 indicates that the mobile station apparatus 5 requests the base station apparatus 3 to allocate an uplink resource, the mobile station apparatus 5 transmit a signal using PUCCH for transmission of SR. When the base station apparatus 3 detects the signal using a resource of PUCCH for transmission of SR, the base station apparatus 3 recognizes that mobile station apparatus 5 is requesting the allocation of the uplink resource. In a case where the mobile station apparatus 5 wants to notify the base station apparatus 3 that the mobile station apparatus 5 does not request the base station apparatus 3 to allocate an uplink resource, the mobile station apparatus 5 does not transmit any signal using a preassigned resource of PUCCH for transmission of SR. When the base station apparatus 3 detects no signal using the resource of PUCCH for transmission of SR, the base station apparatus 3 recognizes that mobile station apparatus 5 is not requesting the allocation of the uplink resource.

PUCCH has different signal configurations depending on whether UCI including ACK/NACK is transmitted, UCI including SR is transmitted, or UCI including CQI is transmitted. PUCCH used for transmission of ACK/NACK is referred to as PUCCH format 1a or PUCCH format 1b. In PUCCH format 1a, BPSK (Binary Phase Shift Keying) is used as a modulation method for modulating information associated with ACK/NACK. In PUCCH format 1a, 1-bit information is represented by a modulated signal. In PUCCH format 1b, QPSK (Quadrature Phase Shift Keying) is used as a modulation method for modulating information associated with ACK/NACK. In PUCCH format 1b, 2-bit information is represented by a modulation signal. PUCCH used for transmission of SR is referred to as PUCCH format 1. PUCCH used for transmission of CQI is referred to as PUCCH format 2. PUCCH used for simultaneous transmission of CQI and ACK/NACK is referred to as PUCCH format 2a or PUCCH format 2b. In PUCCH format 2b, a reference signal (DM RS) of the uplink pilot channel is multiplied by a modulation signal generated from the information associated with ACK/NACK. PUCCH format 2a, 1-bit information associated with ACK/NACK and information associated with CQI are transmitted. In PUCCH format 2b, 2-bit information associated with ACK/NACK and information associated with CQI are transmitted.

One PUSCH includes one or more UL PRBs. One PUCCH includes two UL PRBs that are symmetry in the frequency domain in the uplink system band and located in different uplink slots. One PRACH includes 6 UL PRB pairs. For example, in FIG. 12, in the uplink subframe, one UL PRB pair for PUCCH includes a UL PRB in the lowest frequency band in the first uplink slot and a UL PRB in the lowest frequency band in the second uplink slot. In a case where it is set that the mobile station apparatus 5 does not simultaneously transmit PUSCH and PUCCH, when a resource for PUCCH and a resource for PUSCH are allocated in the same uplink subframe, the mobile station apparatus 5 transmits a signal using only the resource for PUSCH. In a case where it is set that the mobile station apparatus 5 is allowed to simultaneously transmit PUSCH and PUCCH, when a resource for PUCCH and a resource for PUSCH are allocated in the same uplink subframe, the mobile station apparatus 5 is basically capable of transmitting a signal using both the resource for PUCCH and the resource for PUSCH.

UL RS is a signal used for the uplink pilot channel. UL RS includes a demodulation reference signal (DM RS) for use in estimation of change in channel of PUSCH and PUCCH, and a sounding reference signal (SRS) for use in measuring channel equality thereby performing frequency scheduling and adaptive modulation for PUSCH of the base station apparatus 3 and the RRH 4 and for use in measuring a synchronization error between the base station apparatus 3 or the RRH 4 and the mobile station apparatus 5. DM RS is allocated in different SC-FDMA symbols depending on whether it is allocated in the same UL PRB as that of PUSCH or in the same UL PRB as that of PUCCH. DM RS is a signal that is known in the communication system 1 and is used in estimation of change in channel of PUSCH and PUCCH.

In a case where DM RS is allocated in the same UL PRB as that of PUSCH, DM RS is allocated in the fourth SC-FDMA symbol in the uplink slot. In a case where DM RS is allocated in the same UL PRB as that of PUCCH including ACK/NACK, DM RS is allocated in the third, fourth, and fifth SC-FDMA symbols in the uplink slot. In a case where DM RS is allocated in the same UL PRB as that of PUCCH including SR, DM RS is allocated in the third, fourth, and fifth SC-FDMA symbols in the uplink slot. In a case where DM RS is allocated in the same UL PRB as that of PUCCH including CQI, DM RS is allocated in the second and sixth SC-FDMA symbols in the uplink slot.

The SRS is allocated, in a UL PRB determined by the base station apparatus 3, in the 14th SC-FDMA symbol (the 7th SC-FDMA symbol in the second uplink slot in the uplink subframe) in the uplink subframe. The SRS is allowed to be allocated only in an uplink subframe (referred to as a sounding reference signal subframe (SRS subframe)) in a period determined by the base station apparatus 3 in the cell. For the SRS subframe, the base station apparatus 3 assigns the SRS transmission period and the SRS UL PRB to each mobile station apparatus 5.

Although FIG. 12 illustrates a case where the PUCCH is allocated in the UL PRB at an edge, in the frequency domain, of the uplink system band, a UL PRB at a second or third location or the like from the end of the uplink system band may be used for the PUCCH.

In the PUCCH, code division multiplexing in the frequency domain and code division multiplexing in the time domain are used. The code division multiplexing in the frequency domain is processed, in units of subcarriers, by multiplying each code of a code sequence by a modulated signal modulated with uplink control information. The code division multiplexing in the time domain is processed, in units of SC-FDMA symbols, by multiplying each code of a code sequence by a modulation signal modulated with uplink control information. A plurality of PUCCHs are allocated in the same UL PRB, and different codes are assigned to the respective PUCCHs, and the code division multiplexing in the frequency domain or the time domain is achieved using the assigned codes. In the PUCCH used to transmit ACK/NACK (referred to as PUCCH format 1a or PUCCH format 1b), code division multiplexing in the frequency domain and the time domain is used. In the PUCCH used to transmit the SR (referred to as PUCCH format 1), code division multiplexing in the frequency domain and the time domain is used. In the PUCCH used to transmit the CQI, (referred to as PUCCH format 2 or PUCCH format 2a or PUCCH format 2b) code division multiplexing in the frequency domain is used. For simplicity of description, details of the code division multiplexing of the PUCCH are omitted.

A resource for the PUSCH is allocated in an uplink subframe located, in the time domain, a particular number of (for example 4) subframes after a downlink subframe in which a resource for PDCCH including an uplink grant used to assign the resource of PUSCH is allocated.

### <Adding Measuring of Path Loss Based on CSI-RS>

The mobile station apparatus 5 calculates (measures) a path loss based on a CRS. Additionally, the mobile station apparatus 5 calculates (measures) a path loss based on a CSI-RS. The mobile station apparatus 5 calculates the transmission power for the uplink based on the calculated path loss and transmits a signal in the uplink with the transmission power of the calculated value. The base station apparatus 3 sets, for the mobile station apparatus 5, a parameter (configuration) associated with the measurement of the downlink reference signal. Note that in an initial state (default state), the mobile station apparatus 5 calculates the path loss based on the CRS and calculates the value of transmission power for the uplink using the calculated path loss. Note that in the initial state, the mobile station apparatus 5 calculates the path loss based on the CRS of the antenna port 0 or the CRS of the antenna ports 0 and 1.

When determined to be necessary (for example, when it is determined that the mobile station apparatus 5 is close in distance to the RRH 4), the base station apparatus 3 additionally calculates the path loss based on the CSI-RS and makes setting, for the mobile station apparatus 5, so as to make it possible to use it in the transmission power of the uplink. More specifically, the base station apparatus 3 adds or changes (resets or reconfigures) a path loss reference for the mobile station apparatus 5. For example, this change is performed using a RRC signaling. The path loss reference is a specific signal to be measured used in the calculation of the path loss, and a CRS or a CSI-RS may be used as the path loss reference. The base station apparatus 3 is allowed to specify an antenna port of a CSI-RS used by the mobile station apparatus 5 in the calculation of the path loss. In this case, the mobile station apparatus 5 calculates the path loss based on the CSI-RS of the antenna port specified by the base station apparatus 3. Here, the antenna port, of the mobile station apparatus 5, specified by the base station apparatus 3 may be one antenna port, or a plurality of antenna ports or all antenna ports may be specified. The base station apparatus 3 controls the mobile station apparatus 5 such that a signal is transmitted in the uplink with the transmission power calculated using the path loss measured based on the CRS. The base station apparatus 3 controls the mobile station apparatus 5 such that a signal is transmitted in the uplink with the transmission power calculated using the path loss measured based on the CSI-RS. When determined to be necessary, the base station apparatus 3 makes setting, for the mobile station apparatus 5, to stop the measurement of the path loss based on the CSI-RS. This operation is performed in a state in which the mobile station apparatus 5 is calculating the path loss based on the CSI-RS.

Because the value of transmission power of the reference signal in the downlink is necessary in the calculation of the path loss, information associated with the value of transmission power of the CRS and/or information associated with the value of transmission power of the CSI-RS are notified to the mobile station apparatus 5 from the base station apparatus 3.

### <Power Headroom Reporting>

Power headroom reporting is a procedure for providing information, to the base station apparatus 3 and/or the RRH 4, about a difference between a nominal UE maximum transmit power and estimated transmission power for the PUSCH. In a processing hierarchy, the RRC (Radio Resource Control) controls the power headroom reporting, two timers (periodicPHR-Timer and prohibitPHR-Timer) are configured for the control, and a certain parameter (dl-PathlossChange) is subjected to signaling. A sequence of processes to determine the transmission of the power headroom is referred to a power headroom transmission process. The power headroom transmission process is performed (controlled) for each path loss reference.

dl-PathlossChange is a parameter for triggering the transmission of the power headroom when a change occurs in the value of the path loss. Finally, a change in amount of the path loss measured at the current point of time from the path loss measured at the point of time when the power headroom is transmitted is judged with reference to a threshold value given by dl-PathlossChange. In the judgment with reference to the threshold value given by the dl-PathlossChange, if the measured change in the path loss exceeds the dl-PathlossChange, the transmission of the power headroom is triggered. The value of the dl-PathlossChange is expressed in dB. For example, the dl-PathlossChange may take one of the following values: 1 dB, 3 dB, 6 dB, and infinity.

The periodicPHR-Timer is a timer used to trigger, basically periodically, transmission of the power headroom. When the periodicPHR-Timer expires, the transmission of the power headroom is triggered. If the transmission of the power headroom is performed, the periodicPHR-Timer in operation is reset and is restarted. The value of the periodicPHR-Timer is expressed in units of subframes. For example, the periodicPHR-Timer may take one of the following values: 10 subframes, 20 subframes, 50 subframes, 100 subframes, 200 subframes, 500 subframes, 1000 subframes, and infinity.

The prohibitPHR-Timer is a timer for preventing the transmission of the power headroom from being triggered more frequently than needed. When the prohibitPHR-Timer has not yet expired and is in the middle of counting operation, transmission of the power headroom is not triggered even if the measured change in the path loss exceeds the dl-PathlossChange. When the prohibitPHR-Timer expires, transmission of the power headroom is triggered according to the dl-PathlossChange. If the transmission of the power headroom is performed, the prohibitPHR-Timer in operation is reset and is restarted. The value of the prohibitPHR-Timer is expressed in units of subframes. For example, the prohibitPHR-Timer may take one of the following values: 0 subframe, 10 subframes, 20 subframes, 50 subframes, 100 subframes, 200 subframes, 500 subframes, and 1000 subframes.

Parameters of the periodicPHR-Timer, the prohibitPHR-Timer, and the dl-PathlossChange are informed to the mobile station apparatus 5 from the base station apparatus 3 or the RRH 4 using a structure of the RRC signaling called phr-Config. When phr-Config is initialized (configuration of power headroom reporting functionality) or reset (reconfiguration of power headroom reporting functionality), transmission of the power headroom may be triggered.

The power headroom includes a first power headroom and a second power headroom. The first power headroom uses the path loss used in setting the transmission power of the PUSCH used in transmission of the power headroom. The first power headroom is calculated using the bandwidth of the resource allocated for the PUSCH used in transmission of the power headroom. The second power headroom uses a path loss that is not used in setting the transmission power of the PUSCH used in transmission of the power headroom. The second power headroom is calculated without depending on the bandwidth of the resource allocated for the PUSCH used in the transmission of the power headroom. The first power headroom and the second power headroom are transmitted using the same PUSCH.

The value of the first power headroom is a difference between the value of transmission power configured in advance in the mobile station apparatus 5 and a desired value of transmission power for the PUSCH. The desired value of transmission power for the PUSCH is calculated using parameters used in the control of the transmission power according to a predetermined formula (algorithm). For example, the desired value of transmission power for the PUSCH is set so as to satisfy required quality. As for the value of transmission power used in actual transmission of the PUSCH, a smaller value is selected from the two values, i.e., the value of transmission power configured in advance in the mobile station apparatus 5, and the desired value of transmission power for the PUSCH. The value of transmission power configured in advance in the mobile station apparatus 5 is a value of transmission power set in advance by the base station apparatus 3 and/or the RRH 4 for the mobile station apparatus 5 or an upper limit of allowable transmission power available in the mobile station apparatus 5. For example, the available power of the apparatus depends on a class of a power amplifier. The value of the power headroom is expressed in steps of 1 dB in a range [40; −23].

The value of the second power headroom is a difference between the value of transmission power configured in advance in the mobile station apparatus 5 and an assumed value of transmission power for the PUSCH. The assumed value of transmission power for the PUSCH is calculated using the predetermined formula (algorithm) used in the calculation of the desired value of transmission power for the PUSCH such that a predetermined value is applied to a particular parameter in the formula and a particular parameter is not used. For example, as for an assumed bandwidth of the resource for the PUSCH, a particular value (one UL PRB) is used. For example, a particular transmission power offset parameter is not used. As for the path loss, a path loss is used that is different from the path loss used in the calculation of the first power headroom. As for a parameter based on a transmission power control command, a value is used that is set for the transmission power control using the path loss used in the calculation of the second power headroom.

In a case where a downlink reference signal used in the measurement (calculation, estimation) of the path loss is additionally set (configured, changed, reset, reconfigured, rechanged) by the base station apparatus 3 and/or the RRH 4, the mobile station apparatus 5 may go into a state of waiting for a chance to start transmitting the power headroom. The transmission waiting state is can be regarded as a state in which the transmission of the power headroom has been triggered. In the transmission waiting state, when a resource of the PUSCH for new transmission excluding retransmission is allocated by the base station apparatus 3 or the RRH 4, the mobile station apparatus 5 transmits a signal including information associated with the power headroom using the PUSCH allocated the resource. The calculation of the value of the first power headroom is performed basically based on the value of transmission power set for the PUSCH used in the transmission of the power headroom. More precisely, the desired value of transmission power for the PUSCH described above is used in the calculation of the first power headroom. In a case where the desired value of transmission power for the PUSCH described above is smaller than the value of transmission power preconfigured in the mobile station apparatus 5, the value of transmission power for the PUSCH used in the transmission of the power headroom is given by the desired value of transmission power for the PUSCH. In a case where the desired value of transmission power for the PUSCH described above is greater than the value of transmission power preconfigured in the mobile station apparatus 5, the value of transmission power for the PUSCH used in the transmission of the power headroom is given by the value of transmission power preconfigured in the mobile station apparatus 5. Note that a specific signal used in the measurement of the path loss is referred to as a path loss reference. The path loss used in the calculation of the value of transmission power for the uplink is calculated from the set path loss reference. That is, the calculation of the value of the power headroom is performed based on the path loss calculated from the set path loss reference.

For example, in a case where the state is switched from a state in which the path loss is measured based on the CRS to a state in which the path loss is measured and also the path loss is measured based on the CSI-RS, the mobile station apparatus 5 may go into the state of waiting for a chance to start transmitting the power headroom. In this case, the transmission waiting state may be for waiting for a chance to start transmitting the power headroom based on the path loss measured at least from the CSI-RS, or may be for waiting for a chance to start transmitting the power headroom based on the path loss measured from the CRS. For example, in a state in which the mobile station apparatus 5 is performing only a process of measuring the path loss based on the CSI-RS, when a process of measuring the path loss based on the CRS is additionally set, the mobile station apparatus 5 may go into the state of waiting for a chance to start transmitting the power headroom. In this case, the waiting state may be such a state of waiting for a chance to start transmitting the power headroom based on the path loss measured at least from the CRS, or may be such a state of waiting for a chance to start transmitting the power headroom based on the path loss measured from the CSI-RS.

In a case where it is set (configured) to delete, from the base station apparatus 3 or the RRH 4, part of the downlink reference signal used in the measurement (calculation, estimation) of the path loss, the mobile station apparatus 5 may go into the state of waiting for a chance to start transmitting the power headroom. For example, in a case where the state is switched from a state in which the path loss is measured based on the CRS and the path loss is also measured based on the CSI-RS into a state in which the path loss is measured based on only the CRS, the mobile station apparatus 5 may go into the state of waiting for a chance to start transmitting the power headroom. In this case, the waiting state may be such a state of waiting for a chance to start transmitting the power headroom based on the path loss measured from the CRS.

In the communication system in which the path loss reference is additionally set in the mobile station apparatus 5, in a case where the path loss reference is additionally set, the mobile station apparatus 5 may go into the state of waiting for a chance to start transmitting the power headroom. Note that additionally setting the path loss reference means that a specific signal (downlink reference signal) to be used in the measurement of the path loss is additionally set. For example, the mobile station apparatus 5 simultaneously performs in parallel both the processing of measuring the path loss based on the CRS and the process of measuring the path loss based on the CSI-RS. In the case where the path loss reference is additionally set, the mobile station apparatus 5 may go into a state of waiting for a chance to start transmitting the power headroom based on the path loss measured at least from the added path loss reference.

In the mobile station apparatus 5 in which a plurality of different path loss references are set at the same time, a plurality of different types of path losses are measured, measured values of the path losses are held, and the path loss used for the PUSCH may be switched in units of uplink subframes. For example, information of the PDCCH specifies which one of path losses based on the respective path loss references is to be used for the PUSCH. For example, which one of path losses based on the respective path loss references is to be used for the PUSCH is specified based on a channel (PDCCH or E-PDCCH) used in transmission of the uplink grant. For example, it is specified in advance which one of path losses based on the respective path loss references is to be used for which uplink subframe. For example, which one of path losses based on the respective path loss references is to be used for the PUSCH is specified based on a downlink subframe in which the PDCCD including the uplink grant is allocated. In this case, a relationship is set in advance between a downlink subframe number and a corresponding type of path loss reference.

When the mobile station apparatus 5 is in the power headroom transmission waiting state, if a resource for the PUSCH for new transmission is allocated, the mobile station apparatus 5 transmits, using the PUSCH allocated the resource, a signal including information associated with the power headroom waiting for being transmitted.

Details of the power headroom reporting according to the first embodiment are described. In the mobile station apparatus 5 in which a plurality of different path loss references are set at the same time, a plurality of parameters associated with the power headroom reporting are set. For example, a plurality of pieces of dl-PathlossChange are set for a plurality of path loss references. The mobile station apparatus 5 performs a determination as to whether to trigger transmission of an overall power headroom using dl-PathlossChange for each path loss reference. In the case where a plurality of pieces of dl-PathlossChange are set, the judgment as to the change in the path loss with reference to the threshold value given by dl-PathlossChange is performed for a path loss measured from a path loss reference corresponding to the dl-PathlossChange.

Furthermore, in the mobile station apparatus 5 in which a plurality of different path loss references are set at the same time, a common parameter is set for a plurality of processes of transmitting power headrooms. For the plurality of processes of transmitting the power headrooms, a common periodicPHR-Timer is used. The mobile station apparatus 5 controls the transmission of the power headroom such that the common periodicPHR-Timer is used for the process of transmitting the power headroom using the path loss calculated based on each of a plurality of types of reference signals (CRS, CSI-RS), and when the periodicPHR-Timer expires, the power headroom using the path loss calculated based on each type of reference signal is transmitted.

For example, a further description is given below for a case where a CRS and a CSI-RS are set at the same time as path loss references. Let dl-PathlossChange 1 denote dl-PathlossChange corresponding to the CRS, and let dl-PathlossChange 3 denote dl-PathlossChange corresponding to the CSI-RS. Let periodicPHR-Timer 20 denote a common periodicPHR-Timer for the CRS and the CSI-RS. Let prohibitPHR-Timer 400 denote a common prohibitPHR-Timer for the CRS and the CSI-RS. In a case where the periodicPHR-Timer 20 expires, a transmission waiting state occurs for both the power headroom based on the CRS and the power headroom based on the CSI-RS. At a point of time when the power headrooms in the transmission waiting state are transmitted, the periodicPHR-Timer 20 and the prohibitPHR-Timer 400 are reset (restarted), and the counting is started again. In a case where the prohibitPHR-Timer 400 is in the middle of the counting operation (during a period before the timer expires), transmission is prohibited for both the power headroom based on the CRS and the power headroom based on the CSI-RS. dl-PathlossChange 1 is used in the judgment as to the change in the path loss measured from the CRS with reference to the threshold value given by the dl-PathlossChange 1. In a case where the change in the path loss measured from the CRS becomes greater than the value of dl-PathlossChange 1, both the power headroom based on the CRS and the power headroom based on the CSI-RS go into the transmission waiting state. dl-PathlossChange 3 is used in the judgment as to the change in the path loss measured from the CSI-RS with respect to the threshold value given by the dl-PathlossChange 3. In a case where the change in the path loss measured from the CSI-RS becomes greater than the value of dl-PathlossChange 3, both the power headroom based on the CSI-RS and the power headroom based on the CRS go into the transmission waiting state.

### <Overall Configuration of Base Station Apparatus 3>

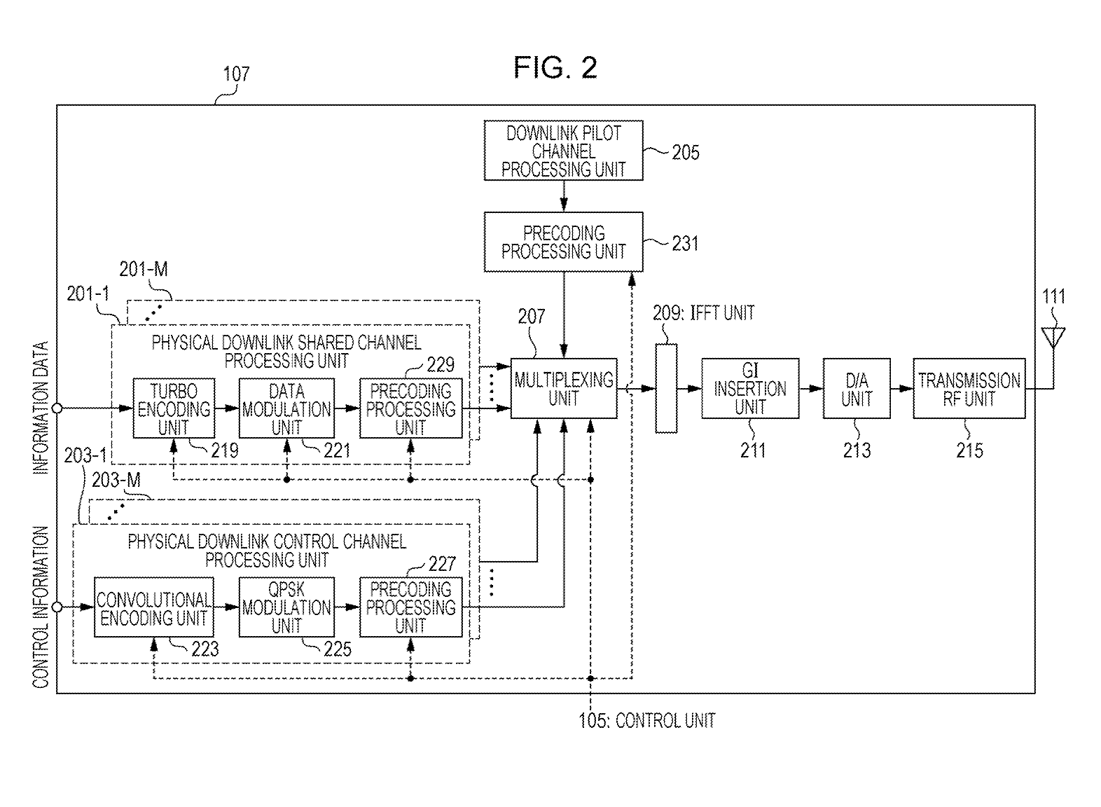

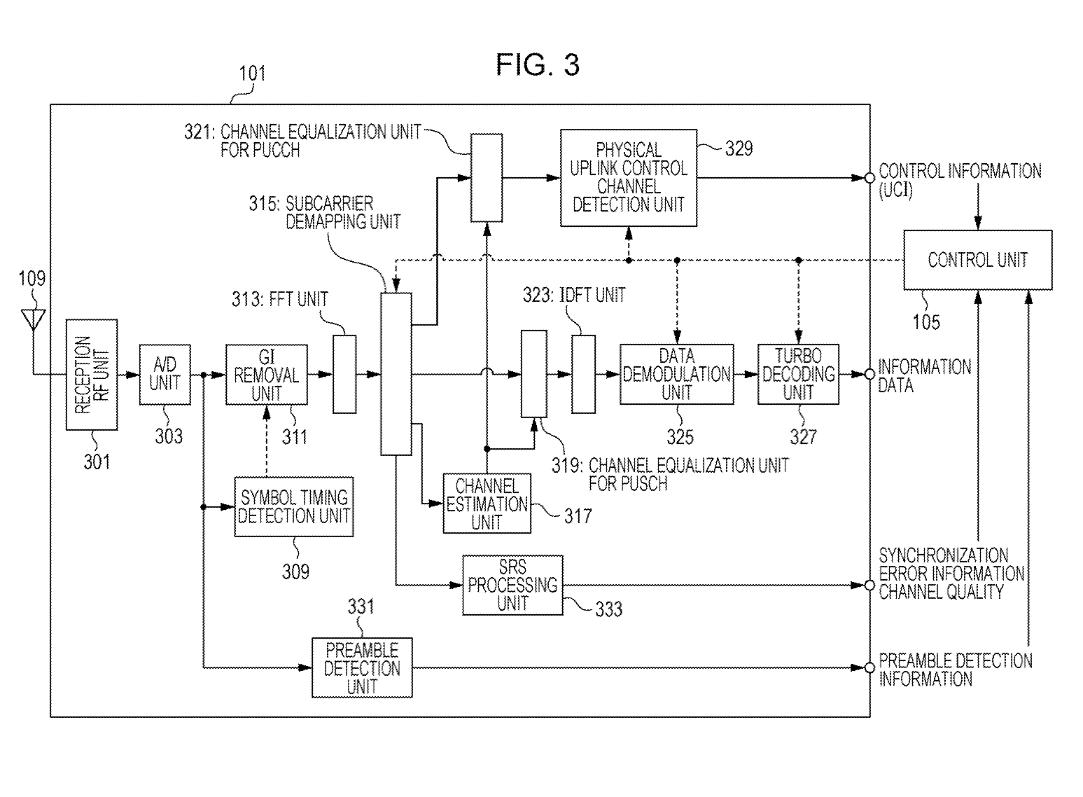

In the following, referring to FIG. 1, FIG. 2, and FIG. 3, a configuration of the base station apparatus 3 according to the present embodiment is described. FIG. 1 is a block diagram schematically illustrating the configuration of the base station apparatus 3 according to the present embodiment of the invention. As illustrated in this figure, the base station apparatus 3 includes a reception processing unit (second reception processing unit) 101 a radio resource control unit (second radio resource control unit) 103, a control unit (second control unit) 105, and a transmission processing unit 107.

Under the control of the control unit 105, the reception processing unit 101 extracts control information and information data by demodulating and decoding, using a UL RS, reception signals of PUCCH and PUSCH received from the mobile station apparatus 5 via a receiving antenna 109. For example, the reception processing unit 101 extracts information associated with the power headroom (the first power headroom and the second power headroom) from the PUSCH. The reception processing unit 101 performs a UCI extraction process on an uplink subframe and a UL PRB therein to which the base station apparatus 3 allocates a resource of the PUCCH. The reception processing unit 101 is instructed by the control unit 105 as to what process is to be performed on which uplink subframe or which UL PRB. For example, the reception processing unit 101 is instructed by the control unit 105 to perform a detection process including multiplying and summing in the time domain between a code sequence and a signal of PUCCH (PUCCH format 1a, PUCCH format 1b) for ACK/NACK and multiplying and summing in the frequency domain between the signal and a code sequence. Note that the reception processing unit 101 receives a notification from the control unit 105 as to the code sequence in the frequency domain and/or the code sequence in the time domain used in the process of detecting the UCI from the PUCCH. The reception processing unit 101 outputs the extracted UCI to the control unit 105 and outputs information data to a higher-level layer. The reception processing unit 101 outputs the extracted UCI to the control unit 105 and outputs information data to a higher-level layer.

Furthermore, under the control of the control unit 105, the reception processing unit 101 detects (receives) a preamble sequence from a received signal of the PRACH received from the mobile station apparatus 5 via the receiving antenna 109. Furthermore, in addition to the detection of the preamble sequence, the reception processing unit 101 also estimates arrival timing (reception timing). The reception processing unit 101 processes the uplink subframe and the UL PRB to which the base station apparatus 3 allocates the resource of the PRACH to detect the preamble sequence. The reception processing unit 101 outputs information associated with the estimated arrival timing to the control unit 105.

The reception processing unit 101 measures channel equality of one or more UL PRBs using the SRS received from the mobile station apparatus 5. Furthermore, the reception processing unit 101 detects (calculates, measures) a synchronization error of the uplink using the SRS received from the mobile station apparatus 5. The reception processing unit 101 is instructed by the control unit 105 as to what process is to be performed on which uplink subframe or which UL PRB. The reception processing unit 101 outputs information associated with the measured channel equality and the detection synchronization error of the uplink to the control unit 105. A further detailed description of the reception processing unit 101 will be given later.

The radio resource control unit 103 performs setting associated with the configuration of the CSI-RS, the allocation of resources for the PDCCH, the allocation of resources for the PUCCH, the allocation of DL PRBs for the PDSCH, the allocation of UL PRBs for the PUSCH, the allocation of resources for the PRACH, the allocation of resources for the SRS, the modulation method, the encoding ratio, the transmission power control value, the phase shift (weighting value) used in the precoding process, and the like for respective types of channels. The radio resource control unit 103 sets parameters (periodicPHR-Timer, prohibitPHR-Timer, dl-PathlossChange) associated with the power headroom reporting. The radio resource control unit 103 sets the downlink reference signals (CRS, CSI-RS) used by the mobile station apparatus 5 in the measurement of the path loss. The radio resource control unit 103 also sets the code sequence in the frequency domain and the code sequence in the time domain for the PUCCH. The radio resource control unit 103 outputs information associated with the set allocation of the resources for PUCCH and the like to the control unit 105. Part of the information set by the radio resource control unit 103 is notified to the mobile station apparatus 5 via the transmission processing unit 107. For example, the information notified to the mobile station apparatus 5 includes information associated with the configuration of the CSI-RS, information indicating values of parameters associated with the power headroom reporting, information indicating a value of part of parameters associated with the transmission power of the PUSCH, and information indicating a value of part of parameters associated with the transmission power of the PUCCH.

The radio resource control unit 103 also makes settings associated with the allocation of the radio resource for the PDSCH based on the UCI acquired by the reception processing unit 101 using the PUCCH and input via the control unit 105. For example, in a case where ACK/NACK acquired using the PUCCH is input, the radio resource control unit 103 allocates, for the mobile station apparatus 5, a resource of PDSCH to which NACK is returned in ACK/NACK.

The radio resource control unit 103 outputs various types of control signals to the control unit 105. For example, the control signals include a control signal indicating the allocation of the resource for the PUSCH, a control signal indicating the phase shift used in the precoding process, and the like.

Based on the control signals input from the radio resource control unit 103, the control unit 105 controls the transmission processing unit 107 in terms of the setting of the CSI-RS, the allocation of DL PRBs for the PDSCH, the allocation of resources for the PDCCH, the setting of the modulation method for the PDSCH, the setting of the encoding ratio for the PDSCH and the PDCCH, the setting associated with the precoding process on the PDSCH and the UE specific RS, and the like. Based on the control signals input from the radio resource control unit 103, the control unit 105 generates DCI to be transmitted using the PDCCH and outputs the generated DCI to the transmission processing unit 107. The DCI to be transmitted using the PDCCH is one associated with the downlink assignment, the uplink grant, and the like.

Based on the control signals input from the radio resource control unit 103, the control unit 105 controls the reception processing unit 101 in terms of the allocation of UL PRBs for the PUSCH, the allocation of resources for the PUCCH, the setting of the modulation method for the PUSCH and the PUCCH, the setting of the encoding ratio for the PUSCH, the detection process for the PUCCH, the setting of the code sequence for the PUCCH, the allocation of resources for the PRACH, the allocation of resources for the SRS. The control unit 105 receives, from the reception processing unit 101, an input of UCI transmitted by the mobile station apparatus 5 using the PUCCH and outputs the input UCI to the radio resource control unit 103.

The control unit 105 also receives, from the reception processing unit 101, inputs of information indicating the arrival timing of the detected preamble sequence, and information indicating the synchronization error of the uplink detected from the received SRS, and the control unit 105 calculates a value of transmission timing adjustment (TA (Timing Advance, Timing Adjustment, Timing Alignment) (TA value) for the uplink. Information indicating the calculated adjustment value of the transmission timing for the uplink (TA command) is notified to the mobile station apparatus 5 via the transmission processing unit 107.

Based on the control signals input from the control unit 105, the transmission processing unit 107 generates signals to be transmitted using the PDCCH or the PDSCH and transmits them via the transmitting antenna 111. The transmission processing unit 107 transmits the information input from the radio resource control unit 103 to the mobile station apparatus 5 using the PDSCH, wherein the information includes the information associated with the configuration of the CSI-RS, the information indicating parameters (periodicPHR-Timer, prohibitPHR-Timer, dl-PathlossChange) associated with the power headroom reporting, the information indicating the downlink reference signals (CRS, CSI-RS) used in the measurement of the path loss, the information indicating a value of part of parameters associated with the transmission power of the PUSCH, the information indicating a value of part of parameters associated with the transmission power of the PUCCH, the information data input from the higher-level later, and the like. On the other hand, the transmission processing unit 107 transmits the DCI input from the control unit 105 to the mobile station apparatus 5 using the PDCCH. In the following, for simplicity of explanation, it is assumed that the information data includes information associated with some types of controls. A further detailed description of the transmission processing unit 107 will be given later.

### <Configuration of Transmission Processing Unit 107 of Base Station Apparatus 3>

The transmission processing unit 107 of the base station apparatus 3 is described in further detail below. FIG. 2 is a block diagram schematically illustrating a configuration of the transmission processing unit 107 of the base station apparatus 3 according to the present embodiment of the invention. As illustrated in this figure, the transmission processing unit 107 includes a plurality of physical downlink shared channel processing units 201-1 to 201-M (hereinafter, the physical downlink shared channel processing units 201-1 to 201-M will be generically referred to as physical downlink shared channel processing unit(s) 201), a plurality of physical downlink control channel processing units 203-1 to 203-M (hereinafter, the physical downlink control channel processing units 203-1 to 203-M will be generically referred to as physical downlink control channel processing unit(s) 203), a downlink pilot channel processing unit 205, a precoding processing unit 231, a multiplexing unit 207, an IFFT (Inverse Fast Fourier Transform) unit 209, a GI (Guard Interval) insertion unit 211, a D/A (Digital/Analog converter) unit 213, a transmission RF (Radio Frequency) unit 215, and a transmitting antenna 111. Each of the physical downlink shared channel processing units 201 and also each of the physical downlink control channel processing units 203 are similar in structure and function, and thus a representative one is described below. Note that for simplicity of explanation, the transmitting antenna 111 includes a plurality of antenna ports.

As illustrated in this figure, each of the physical downlink shared channel processing units 201 includes a turbo encoding unit 219, a data modulation unit 221, and a precoding processing unit 229. Furthermore, as illustrated in this figure, the physical downlink control channel processing unit 203 includes a convolutional encoding unit 223, a QPSK modulation unit 225 and a precoding processing unit 227. The physical downlink shared channel processing unit 201 performs baseband signal processing for transmitting information data by an OFDM scheme to the mobile station apparatus 5. The turbo encoding unit 219 performs turbo encoding on the input information data with the encoding ratio input by the control unit 105 so as to enhance the data error resilience, and the turbo encoding unit 219 outputs the result to the data modulation unit 221. The data modulation unit 221 modulates the data encoded by the turbo encoding unit 219 by the modulation method input by the control unit 105, for example, QPSK (Quadrat re Phase Shift Keying), 16 QAM (16 Quadrature Amplitude Modulation), 64 QAM (64 Quadrature Amplitude Modulation) or the like thereby generating a signal sequence of modulation symbols. The data modulation unit 221 outputs the generated signal sequence to the precoding processing unit 229. The precoding processing unit 229 performs a precoding process (beam forming process) on the signal input from the data modulation unit 221 and outputs the result to the multiplexing unit 207. In the precoding process, phase shifting or the like may preferably performed on the generated signal to make it possible for the mobile station apparatus 5 to efficiently receive the signal (for example, so as to achieve maximum reception power, minimize interference, and the like).

The physical downlink control channel processing unit 203 performs baseband signal processing, for transmission by the OFDM scheme, on the DCI input from the control unit 105. The convolutional encoding unit 223 performs convolution encoding, for enhancement of error resilience, on the DCI based on the encoding ratio input from the control unit 105. Note that the DCI is controlled in units of bits. To adjust the number of output bits, the convolutional encoding unit 223 also performs rate matching on the bits subjected to the convolution encoding based on the encoding ratio input from the control unit 105. The convolutional encoding unit 223 outputs the encoded DCI to the QPSK modulation unit 225. The QPSK modulation unit 225 performs QPSK modulation on the DCI encoded by the convolutional encoding unit 223 and outputs the resultant signal sequence of modulation symbols to the precoding processing unit 227. The precoding processing unit 227 performs a precoding process on the signal input from the QPSK modulation unit 225 and outputs the result to the multiplexing unit 207. Note that the precoding processing unit 227 may directly output the signal input from the QPSK modulation unit 225 to the multiplexing unit 207 without performing the precoding process.

The downlink pilot channel processing unit 205 generates the downlink reference signal (CRS, UE specific RS, CSI-RS) that is a signal known by the mobile station apparatus 5 and outputs the generated downlink reference signal to the precoding processing unit 231. For the CRS and the CSI-RS input from the downlink pilot channel processing unit 205, the precoding processing unit 231 does not perform the precoding process and directly outputs them to the multiplexing unit 207. For the UE specific RS input from the downlink pilot channel processing unit 205, the downlink pilot channel processing unit 205 performs the precoding process and outputs the result to the multiplexing unit 207. Note that the precoding processing unit 231 performs the process on the UE specific RS in a similar manner to the manner in which the precoding processing unit 229 performs the process on the PDSCH and/or to the manner in which the precoding processing unit 227 performed the process on the PDCCH. Therefore, when the signal of the PDSCH or the PDCCH subjected to the precoding process is demodulated in the mobile station apparatus 5, the UE specific RS allows it to estimate a channel equalization that is a combination of the change in the channel (transmission line) of the downlink and the phase shift generated by the precoding processing unit 229 or the precoding processing unit 227. Therefore, the base station apparatus 3 does not need to notify the mobile station apparatus 5 of the information (phase shift) associated with the precoding process performed by the precoding processing unit 229 or the precoding processing unit 227, and the mobile station apparatus 5 is capable of demodulating the signal subjected to the precoding process (transmitted in the cooperative multipoint communication mode) without needing the modification. In a case where the precoding process is not performed on the PDSCH that is to be subjected to the demodulation process such as channel compensation using the UE specific RS, the precoding processing unit 231 directly outputs the UE specific RS to the multiplexing unit 207 without performing the precoding process on the UE specific RS.

Under the control of the control unit 105, the multiplexing unit 207 multiplexes the signal input from the downlink pilot channel processing unit 205, the signals input from the respective physical downlink shared channel processing units 201, and the signals input from the respective physical downlink control channel processing units 203 into the downlink subframe. The control signals associated with the allocation of the DL PRB for the PDSCH and the allocation of the resource for the PDCCH set by the radio resource control unit 103 are input to the control unit 105, and the control unit 105 controls the process performed by the multiplexing unit 207 based on the control signals.

Note that the multiplexing unit 207 multiplexes the PDSCH and the PDSCH basically by the time division multiplexing as illustrated in FIG. 9. On the other hand, the multiplexing unit 207 multiplex the downlink pilot channel and other channel by the time/frequency division multiplexing. The multiplexing unit 207 multiplexes the PDSCH addressed to the respective mobile station apparatuses 5 in units of DL PRB pairs. The multiplexing unit 207 may multiplex the PDSCH addressed to one mobile station apparatus 5 using a plurality of DL PRB pairs. The multiplexing unit 207 outputs the multiplexed signal to the IFFT unit 209.

The IFFT unit 209 performs a fast inverse Fourier transform on the signal multiplexed by the multiplexing unit 207 and performs an OFDM modulation. The IFFT unit 209 outputs the result to the GI insertion unit 211. GI insertion unit 211 adds a guard interval to the signal subjected to the OFDM modulation by the IFFT unit 209 thereby generating a baseband digital signal including OFDM symbols. As is well known, the guard interval is generated by making a copy of a top or end portion of an OFDM symbol to be transmitted. The GI insertion unit 211 outputs the generated baseband digital signal to the D/A unit 213. The D/A unit 213 converts the baseband digital signal input from the GI insertion unit 211 to an analog signal and outputs the resultant analog signal to the transmission RF unit 215. The transmission RF unit 215 generates an in-phase component and a quadrature component with an intermediate frequency from the analog signal input from the D/A unit 213 and removes frequency components unnecessary for the intermediate frequency band. The transmission RF unit 215 then converts (up-converts) the intermediate frequency signal to a high frequency signal, removes unnecessary frequency components, and performs power amplification. The transmission RF unit 215 transmits the resultant signal to the mobile station apparatus 5 via the transmitting antenna 111.

### <Configuration of Reception Processing Unit 101 of Base Station Apparatus 3>

In the following, details of the reception processing unit 101 of the base station apparatus 3 are described. FIG. 3 is a block diagram schematically illustrating a configuration of the reception processing unit 101 of the base station apparatus 3 according to the present embodiment of the invention. As illustrated in this figure, the reception processing unit 101 includes a reception RF unit 301, an A/D (Analog/Digital converter) unit 303, a symbol timing detection unit 309, a GI removal unit 311, a FFT unit 313, a subcarrier demapping unit 315, a channel estimation unit 317, a channel equalization unit 319 for PUSCH, a channel equalization unit 321 for PUCCH, an IDFT unit 323, a data demodulation unit 325, a turbo decoding unit 327, a physical uplink control channel detection unit 329, a preamble detection unit 331, and an SRS processing unit 333.

The reception RF unit 301 amplifies the signal received by the receiving antenna 109 in a proper manner, converts (down-converts) it into an intermediate frequency, removes unnecessary frequency components, controls the amplification level such that the signal level is maintained proper, and performs a quadrature demodulation based on an in-phase component and a quadrature component of the received signal. The reception RF unit 301 outputs the quadrature-demodulated analog signal to the A/D unit 303. The A/D unit 303 converts the analog signal quadrature-demodulated by the reception RF unit 301 into a digital signal and outputs the converted digital signal to the symbol timing detection unit 309, the GI removal unit 311, and the preamble detection unit 331.

The symbol timing detection unit 309 detects symbol timing based on the signal input from the A/D unit 303 and outputs a control signal indicating the detected timing of a boundary between symbols to the GI removal unit 311. Based on the control signal from the symbol timing detection unit 309, the GI removal unit 311 removes part corresponding to the guard interval from the signal input from the A/D unit 303 and outputs the remaining part of the signal to the FFT unit 313. The FFT unit 313 performs a fast Fourier transform on the signal input from the GI removal unit 311 and performs a DFT-Spread-OFDM demodulation. The FFT unit 313 outputs the result to the subcarrier demapping unit 315. Note that the number of points used by the FFT unit 313 is equal to the number of points used by the IFFT unit of the mobile station apparatus 5 descried later.

Based on the control signal input from the control unit 105, the subcarrier demapping unit 315 demultiplexes the signal demodulated by the FFT unit 313 into a DM RS, an SRS, a PUSCH signal, and a PUCCH signal. The subcarrier demapping unit 315 outputs the demultiplexed DM RS to the channel estimation unit 317, the demultiplexed SRS to the SRS processing unit 333, the demultiplexed PUSCH signal to the PUSCH channel equalization unit 319, and the demultiplexed PUCCH signal to the PUCCH channel equalization unit 321.

The channel estimation unit 317 estimates a change in channel using a known signal and the DM RS demultiplexed by the subcarrier demapping unit 315. The channel estimation unit 317 outputs the resultant estimated channel value to the PUSCH channel equalization unit 319 and the PUCCH channel equalization unit 321. The PUSCH channel equalization unit 319 equalizes the amplitude and the phase of the PUSCH signal demultiplexed by the subcarrier demapping unit 315 based on the estimated channel value input from the channel estimation unit 317. Here, the equalization is a process of cancelling out the change in the channel occurring during the wireless signal communication. The PUSCH channel equalization unit 319 outputs the equalized signal to the IDFT unit 323.

The IDFT unit 323 performs an inverse discrete Fourier transform on the signal input from the PUSCH channel equalization unit 319 and outputs the result to the data demodulation unit 325. The data demodulation unit 325 demodulates the PUSCH signal converted by the IDFT unit 323 and outputs the demodulated PUSCH signal to the turbo decoding unit 327. This demodulation is performed according to a method corresponding to the modulation employed by the data modulation unit of the mobile station apparatus 5, and the modulation method is input from the control unit 105. The turbo decoding unit 327 decodes information data from the demodulated PUSCH signal input from the data demodulation unit 325. The encoding ratio is input from the control unit 105.

The PUCCH channel equalization unit 321 equalizes the amplitude of the phase of the PUCCH signal demultiplexed by the subcarrier demapping unit 315 based on the estimated channel value input from the channel estimation unit 317. The PUCCH channel equalization unit 321 outputs the equalized signal to the physical uplink control channel detection unit 329.

The physical uplink control channel detection unit 329 demodulates and decodes the signal input from the PUCCH channel equalization unit 321 and detects UCI. The physical uplink control channel detection unit 329 performs a process to demultiplex signals code-division multiplexed in the frequency domain and/or the frequency domain. The physical uplink control channel detection unit 329 performs a process to detect ACK/NACK, SR, and CQI from the PUCCH signal code-division multiplexed in the frequency domain and/or time domain using the code sequence used at the transmission side. More specifically, as for the detection process using the code sequence in the frequency domain, that is, as for the process of demultiplexing the signal code-division multiplexed in the frequency domain, the physical uplink control channel detection unit 329 multiplies the signal of each PUCCH subcarrier by each code of the code sequence and then combines the resultant signals multiplied by the respective codes. On the other hand, as for the detection process using the code sequence in the time domain, that is, as for the process of demultiplexing the signal code-division multiplexed in the time domain, the physical uplink control channel detection unit 329 multiplies the signal of each PUCCH SC-FDMA symbol by each code of the code sequence and then combines the resultant signals multiplied by the respective codes. Note that the physical uplink control channel detection unit 329 sets the detection process performed on the PUCCH signal based on the control signal from the control unit 105.

The SRS processing unit 333 measures channel equality using the SRS input from the subcarrier demapping unit 315 and outputs the measurement result of the channel equality of the UL PRB to the control unit 105. The SRS processing unit 333 receives an instruction from the control unit 105 as to the channel equality of the mobile station apparatus 5 is to be performed on a signal in which UL PRB in which uplink subframe. The SRS processing unit 333 detects an uplink synchronization error using the SRS input from the subcarrier demapping unit 315, and outputs information (synchronization error information) indicating the uplink synchronization error to the control unit 105. Alternatively, the SRS processing unit 333 may perform a process to detect the uplink synchronization error from the received signal in the time domain. A concrete process therefor may be similar to a process performed by the preamble detection unit 331 described below.

The preamble detection unit 331 detects a preamble transmitted in response to a received signal corresponding to PRACH based on the signal input from the A/D unit 303. More specifically, the preamble detection unit 331 detects correlations of received signals of various timings in the guard time with replica signals generated using respective preamble sequences that can be transmitted. For example, in a case where the correlation value is higher than a preset threshold value, the preamble detection unit 331 determines that the signal transmitted from the mobile station apparatus 5 is the same as the preamble sequence used to generate the replica signal used in the correlation detection process. The preamble detection unit 331 determines that timing with the highest correlation value is the arrival timing of the preamble sequence. The preamble detection unit 331 then generates preamble detection information including at least information indicating the detected preamble sequence and information indicating the arrival timing, and outputs the generated preamble detection information to the control unit 105.

Based on the control information (DCI) transmitted by the base station apparatus 3 using the PDCCH to the mobile station apparatus 5 and the control information transmitted using the PDSCH, the control unit 105 controls the subcarrier demapping unit 315, the data demodulation unit 325, the turbo decoding unit 327, the channel estimation unit 317, and the physical uplink control channel detection unit 329. Furthermore, based on the control information transmitted by the base station apparatus 3 to the mobile station apparatus 5, the control unit 105 recognizes which resource (uplink subframe, UL PRB, code sequence in the frequency domain, code sequence in the time domain, preamble sequence) is included in the PRACH, PUSCH, PUCCH, and SRS transmitted (or can have been transmitted) by each mobile station apparatus 5.

### <Overall Configuration of Mobile Station Apparatus 5>

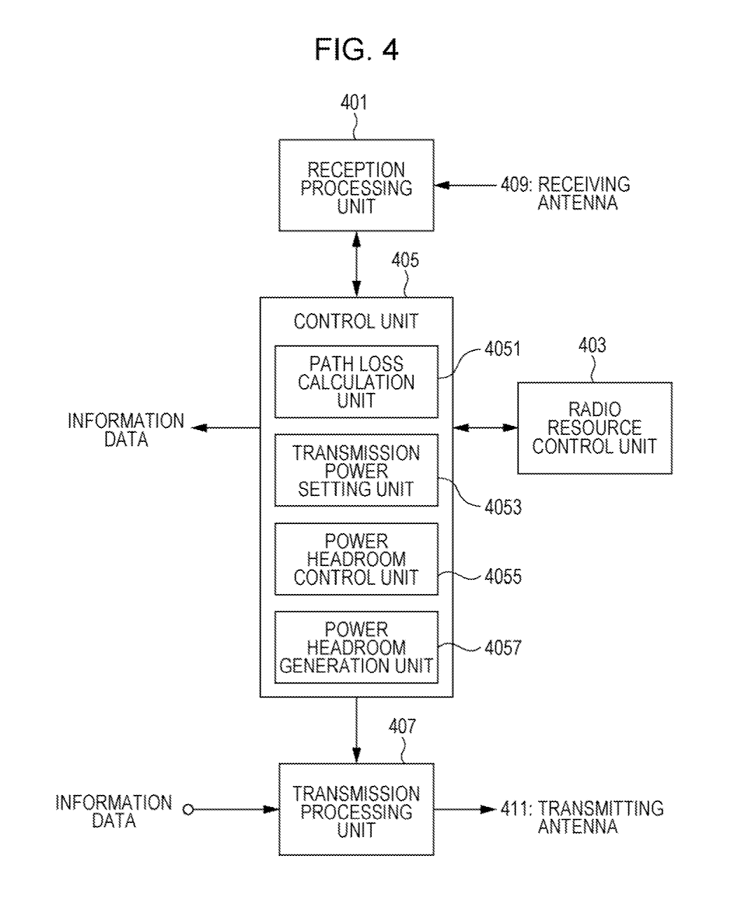

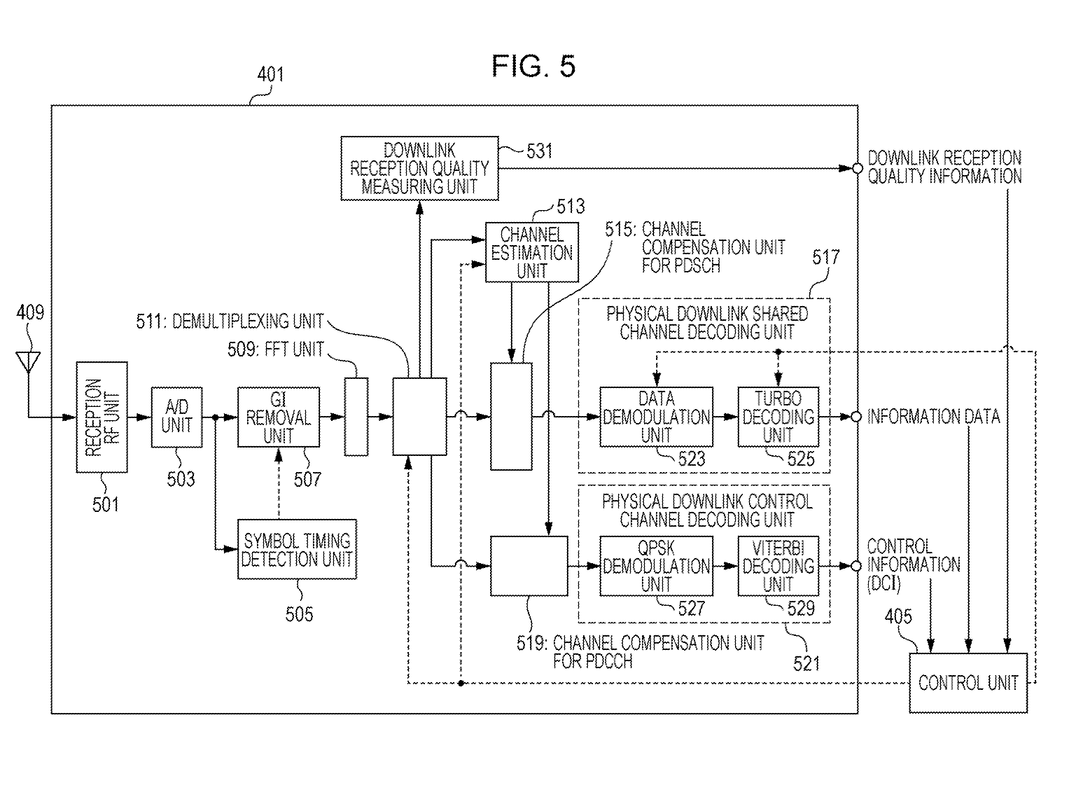

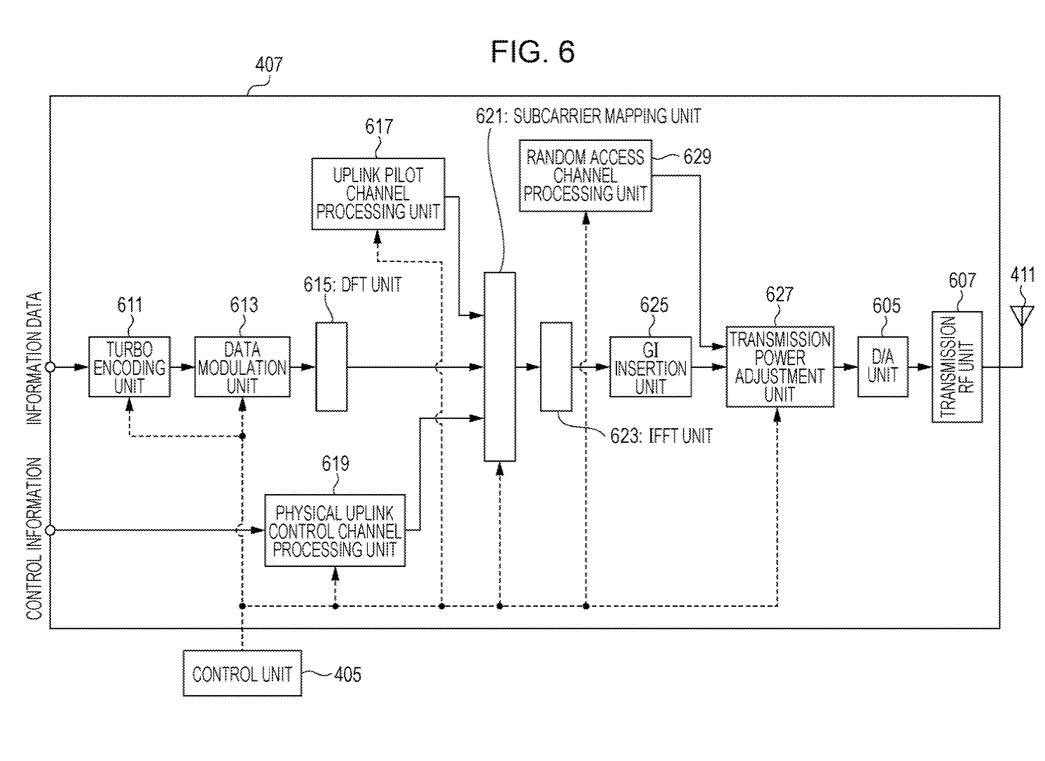

In the following, referring to FIG. 4, FIG. 5, and FIG. 6, a configuration of the mobile station apparatus 5 according to the present embodiment is described. FIG. 4 is a block diagram schematically illustrating the configuration of the mobile station apparatus 5 according to the present embodiment of the invention. As illustrated in this figure, the mobile station apparatus 5 includes a reception processing unit (first reception processing unit) 401, a radio resource control unit (first radio resource control unit) 403, a control unit (first control unit) 405, and a transmission processing unit 407. The control unit 405 also includes a path loss calculation unit 4051, a transmission power setting unit 4053, a power headroom control unit 4055 and a power headroom generation unit 4057.

The reception processing unit 401 receives a signal from the base station apparatus 3, and demodulates and decodes the received signal under the control of the control unit 405. In a case where the reception processing unit 401 receives a PDCCH signal addressed to the mobile station apparatus 5, the reception processing unit 401 decodes the PDCCH signal to acquire DCI, and outputs the acquired DCI to the control unit 405. For example, control information associated with a PUCCH resource included in the PDCCH is output from the reception processing unit 401 to the control unit 405. Furthermore, based on an instruction given by the control unit 405 after the DCI included in the PDCCH is output to the control unit 405, the reception processing unit 401 outputs information data obtained by decoding a PDSCH addressed to the mobile station apparatus 5 to a higher-level layer via the control unit 405. The downlink assignment in the DCI included in the PDCCH includes information indicating a resource allocated for the PDSCH. Furthermore, the reception processing unit 401 outputs control information, obtained by decoding the PDSCH and originally generated by the radio resource control unit 103 of the base station apparatus 3, to the control unit 405 and also to the radio resource control unit 403 of the mobile station apparatus 5 via the control unit 405. For example, the control information generated by the radio resource control unit 103 of the base station apparatus 3 includes information associated with the configuration of the CSI-RS, information indicating a downlink reference signal used in measurement of a path loss, information indicating a value of a parameter associated with power headroom reporting, information indicating a value of part of parameters associated with transmission power of the PUSCH, and information indicating a value of part of parameters associated with transmission power of the PUCCH.

The reception processing unit 401 also outputs a cyclic redundancy check (CRC) code included in the PDSCH to the control unit 405. Although not described in the explanation of the base station apparatus 3, the transmission processing unit 107 of the base station apparatus 3 generates a CRC code from information data and transmits the information data and the CRC code using the PDSCH. The CRC code is used to determine whether or not data included in the PDSCH has an error. For example, in a case where information generated by the mobile station apparatus 5 from the data using a predetermined generator polynomial is identical to the CRC code generated by the base station apparatus 3 and transmitted using the PDSCH, it is determined that the data does not have any error. On the other hand, in a case where information generated by the mobile station apparatus 5 from the data using the predetermined generator polynomial is different from the CRC code generated by the base station apparatus 3 and transmitted using the PDSCH, it is determined that the data has an error.

Furthermore, the reception processing unit 401 measures downlink reception quality (RSRP (Reference Signal Received Power)) and outputs the measurement result to the control unit 405. The reception processing unit 401 measures (calculates) the RSRP from the CRS or CSI-RS under the control of the control unit 405. A further detailed description of the reception processing unit 401 will be given later.

The control unit 405 includes a path loss calculation unit 4051, a transmission power setting unit 4053, a power headroom control unit 4055, and a power headroom generation unit 4057. The control unit 405 recognizes the data transmitted from the base station apparatus 3 using the PDSCH and input from the reception processing unit 401, outputs the information data in the data to the higher-level layer, and controls the reception processing unit 401 and the transmission processing unit 407 based on the control information, in the data, generated by the radio resource control unit 103 of the base station apparatus 3. Furthermore, based on an instruction from the radio resource control unit 403, the control unit 405 controls the reception processing unit 401 and the transmission processing unit 407. For example, based on information indicating a downlink reference signal used in measurement of a path loss, the control unit 405 sets the downlink reference signal for measurement of the RSPP in the reception processing unit 401. For example, the control unit 405 controls the transmission processing unit 407 to transmit a signal including the information associated with the power headroom using the PUSCH specified by the radio resource control unit 403.

Furthermore, the control unit 405 controls the reception processing unit 401 and the transmission processing unit 407 based on the DCI transmitted from the base station apparatus 3 using the PDCCH and input from the reception processing unit 401. More specifically, the control unit 405 controls the reception processing unit 401 based on the detected downlink assignment and controls the transmission processing unit 407 based on the detected uplink grant. Furthermore, the control unit 405 compares the data input from the reception processing unit 401 using the predetermined generator polynomial with the CRC code input from the reception processing unit 401 to determine whether the data has an error or not, and the control unit 405 generates ACK/NACK. Furthermore, the control unit 405 generates a SR and CQI based on an instruction from the radio resource control unit 403. Furthermore, the control unit 405 controls the transmission timing of a signal transmitted by the transmission processing unit 407 based on an adjustment value of the like of the uplink transmission timing informed from the base station apparatus 3.

The path loss calculation unit 4051 calculates a path loss using the RSRP input from the reception processing unit 401. The reception processing unit 401 measures the RSPP for the CRS and the RSRP for the CSI-RS, and inputs the measured RSRP values to the path loss calculation unit 4051. The path loss calculation unit 4051 calculates the path loss using the RSRP for the CRS, and calculates the path loss using the RSRP for the CSI-RS. For example, the path loss is calculated by subtracting an averaged RSRP value from a value of transmission power of the downlink reference signal. For example, the averaging is performed by adding a value obtained by multiplying a value averaged using a predetermined filter coefficient (filterCoefficent) by (I-filterCoefficent) with a value obtained by multiplying a newly measured value by filterCoefficent. Note that the value of the filter coefficient (filterCoefficent) used in the mobile station apparatus 5 is set by the base station apparatus 3 or the RRH 4. The path loss calculation unit 4051 outputs information associated with the calculated path losses (the path loss based on the CRS and the path loss based on the CSI-RS) to the transmission power setting unit 4053, the power headroom control unit 4055 and the power headroom generation unit 4057.

The transmission power setting unit 4053 sets the transmission power of the uplink. The setting of the transmission power by the transmission power setting unit 4053 is performed for the PUSCH, the PUCCH, the DM RS, the SRS, and the PRACH. The transmission power setting unit 4053 properly sets the transmission power for the PUSCH based on the path loss input from the path loss calculation unit 4051, a coefficient multiplied by the path loss, a parameter based on the number of UL PRBs allocated for the PUSCH (the band width of the resource allocated for the PUSCH), cell-specific and mobile station apparatus-specific parameters notified in advance from the base station apparatus 3 or the RRH 4, a parameter based on a transmission power control command notified from the base station apparatus 3 or the RRH 4, and the like. The transmission power setting unit 4053 properly sets the transmission power for the PUCCH based on the path loss input from the path loss calculation unit 4051, a parameter based on a signal configuration of the PUCCH, a parameter based on an information amount transmitted using the PUCCH, cell-specific and mobile station apparatus-specific parameters notified in advance from the base station apparatus 3 or the RRH 4, a parameter based on a transmission power control command notified from the base station apparatus 3 or the RRH 4, and the like. The transmission power setting unit 4053 properly sets the transmission power for the SRS based on the path loss input from the path loss calculation unit 4051, a coefficient multiplied by the path loss, a parameter based on the number of UL PRBs allocated for the SRS, cell-specific and mobile station apparatus-specific parameters notified in advance from the base station apparatus 3 or the RRH 4, an offset notified in advance from the base station apparatus 3 or the RRH 4, and a parameter based on a transmission power control command notified from the base station apparatus 3 or the RRH 4, and the like. For the DM RS, the transmission power setting unit 4053 sets the transmission power in a similar manner to a physical channel for which the DM RS is allocated.

Note that the various kinds of parameters described above may be set by the base station apparatus 3 or the RRH 4 using signaling, or values may be uniquely set according to specifications, or values may be set depending on other various factors. As described above, the transmission power setting unit 4053 sets transmission power for channels or signals transmitted in respective uplink subframes using one of the plurality of path losses input from the path loss calculation unit 4051. The transmission power setting unit 4053 controls the transmission processing unit 407 so as to use a set desirable value of transmission power or a value of transmission power configured in advance in the mobile station apparatus 5. The transmission power setting unit 4053 makes a comparison between the value of transmission power configured in advance in the mobile station apparatus 5 and the desired value of transmission power, and selects a smaller one. The transmission power setting unit 4053 controls the transmission processing unit 407 so as to use the selected value of transmission power.

In the transmission power setting unit 4053, two modes are used in the setting of parameters based on a transmission power control command. In one mode (Accumulation mode), values notified via transmission power control commands are accumulated. In the other mode (Absolute mode), notified values of a plurality of transmission power control commands are not accumulated, but only a value of a newest transmission power control command is used. For example, for the PUSCH, either the accumulation mode or the absolute mode is set in the mobile station apparatus 5 using RRC signaling. For the PUCCH, the accumulation mode is set in the mobile station apparatus 5.

The transmission power setting unit 4053 controls transmission power independently for each path loss input from the path loss calculation unit 4051. More specifically, the transmission power setting unit 4053 executes a plurality of independent transmission power setting processes and uses different path losses in the respective transmission power setting processes. For the transmission power setting processes in which different path losses are used, independent parameters are notified from the base station apparatus 3 or the RRH 4, and notified independent parameters are used. For example, for the transmission power setting processes in which different path losses are used, coefficients that are multiplied by the respective path losses, sell-specified and mobile station apparatus-specific parameters notified from the base station apparatus 3 or the RRH 4 in advance, and transmission power control commands notified from the base station apparatus 3 or the RRH 4 are notified from the base station apparatus 3 or the RRH 4 and used. Note that as for the independent parameters of the transmission power setting processes in which different path losses are used, actual values thereof can be equal. For the transmission power setting processes in which different path losses are used, part of parameters may be used in common. Note that for part of signal in the uplinks, the path loss for use in the setting of transmission power may be switched in units of uplink subframes, but for another part of the signal in the uplinks, only one path loss may be used in the setting of transmission power without switching the path loss in units of uplink subframes. For example, for the PUSCH, the path loss for each uplink subframe may be switched between the path loss based on the CRS and the path loss based CSI-RS, while for the PUCCH, the path loss based on the CSI-RS may be used without switching the path loss in units of uplink subframes.

The power headroom control unit 4055 controls the power headroom reporting. The power headroom control unit 4055 controls the transmission of the power headroom using parameters (periodicPHR-Timer, prohibitPHR-Timer, dl-PathlossChange) associated with the power headroom reporting and the path loss input from the path loss calculation unit 4051. Furthermore, based on the information notified from the base station apparatus 3 or the RRH 4, the power headroom control unit 4055 may determine to transmit the power headroom in response to an event of setting of additional type of downlink reference signal (CRS or CSI-RS) used in the calculation by the path loss calculation unit 4051. In a case where the power headroom control unit 4055 determines to transmit the power headroom, the power headroom control unit 4055 controls the transmission processing unit 407 to transmit information associated with the power headroom using the PUSCH. In the case where the power headroom control unit 4055 determines to transmit the power headroom, the power headroom control unit 4055 instructs the power headroom generation unit 4057 to generate the power headroom and controls it.

For the power headroom control unit 4055, a plurality of parameters associated with the power headroom reporting are set. The parameters are set independently for the power headroom reporting using the path loss based on CRS and the power headroom reporting using the path loss based on the CSI-RS. In the power headroom control unit 4055, a plurality of pieces of dl-PathlossChange are set for a plurality of path loss references. The power headroom control unit 4055 determines whether to trigger the transmission of the overall power headroom using the dl-PathlossChange for each path loss reference. The power headroom control unit 4055 makes a judgment as to the change in path loss with reference to the threshold value given by dl-PathlossChange for the path loss measured from the path loss reference corresponding to dl-PathlossChange. The power headroom control unit 4055 uses independent dl-PathlossChange for each of the transmission processes, that is, for each of the process of transmitting the power headroom using the path loss calculated based on the CRS (first reference signal) and the process of transmitting the power headroom using the path loss calculated based on the CSI-RS (second reference signal), and in a case where either one of the path losses changes by an amount equal to or greater than dl-PathlossChange, the power headroom control unit 4055 determines to transmit (trigger (start) transmission) the power headroom using the path loss calculated based on the CRS (first reference signal) and the power headroom using the path loss calculated based on the CSI-RS (second reference signal). The power headroom control unit 4055 performs controlling such that when a determination is made to transmit (trigger (start) transmission) the power headroom using the path loss calculated based on the CRS (first reference signal) and the power headroom using the path loss calculated based on the CSI-RS (second reference signal), the power headrooms (the first power headroom and the second power headroom described below) are transmitted using a PUSCH to which a resource is allocated first after the determination.

In the power headroom control unit 4055, common periodicPHR-Timer is set for a plurality of processes of transmitting power headrooms respectively corresponding to different path loss references. The power headroom control unit 4055 performs controlling such that in a case where the periodicPHR-Timer expires, the power headrooms using the path losses calculated based on the CRS and CSI-RS respectively. The power headroom control unit 4055 uses common periodicPHR-Timer for both the transmission processes, that is, for both the process of transmitting the power headroom using the path loss calculated based on the CRS (first reference signal) and the process of transmitting the power headroom using the path loss calculated based on the CSI-RS (second reference signal), and in a case where the periodicPHR-Timer expires, the power headroom control unit 4055 determines to transmit (trigger transmission) the power headroom using the path loss calculated based on the CRS (first reference signal) and the power headroom using the path loss calculated based on the CSI-RS (second reference signal). The power headroom control unit 4055 performs controlling such that when a determination is made to transmit (trigger transmission) the power headroom using the path loss calculated based on the CRS (first reference signal) and the power headroom using the path loss calculated based on the CSI-RS (second reference signal), the power headrooms (the first power headroom and the second power headroom described below) are transmitted using a PUSCH to which a resource is allocated first after the determination.

The mobile station apparatus 5 recognizes the allocation of a resource for the PUSCH from the received UL grant. In response to recognizing the allocation of the resource for the PUSCH, the power headroom control unit 4055 executes related processes. Information associated with the band width of the allocated resource for the PUSCH is input to the transmission power setting unit 4053 and the power headroom generation unit 4057.

The power headroom generation unit 4057 generates power headrooms. The power headroom is information associated with a margin of transmission power. The power headroom generation unit 4057 generates the first power headroom and the second power headroom. The power headroom generation unit 4057 generates the first power headroom based on nominal UE maximum transmit power, a path loss input from the path loss calculation unit 4051, a coefficient multiplied by the path loss, a parameter based on the number of UL PRBs allocated for the PUSCH (the band width of the resource allocated for the PUSCH), cell-specific and mobile station apparatus-specific parameters notified in advance from the base station apparatus 3 or the RRH 4, and a parameter based on a transmission power control command notified from the base station apparatus 3 or the RRH 4. Another parameter may be added to those described above for use in the generation of the first power headroom. The power headroom generation unit 4057 calculates desired transmission power for the PUSCH based on a path loss input from the path loss calculation unit 4051, a coefficient multiplied by the path loss, a parameter based on the number of UL PRBs allocated for the PUSCH (the band width of the resource allocated for the PUSCH), cell-specific and mobile station apparatus-specific parameters notified in advance from the base station apparatus 3 or the RRH 4, and a parameter based on a transmission power control command notified from the base station apparatus 3 or the RRH 4. The power headroom generation unit 4057 subtracts the desired transmission power for the PUSCH from the nominal maximum transmission power of the mobile station, and employs the resultant value as information indicating the first power headroom. The path loss used in the generation of the first power headroom is a path loss used in setting the transmission power of the PUSCH used to transmit the first power headroom. Of the parameters used in the generation of the first power headroom, the coefficient multiplied by the path loss, the cell-specific and mobile station apparatus-specific parameters notified in advance from the base station apparatus 3 or the RRH 4, and the parameter based on the transmission power control command notified from the base station apparatus 3 or the RRH 4 are those corresponding to the path loss used in the generation of the first power headroom. In the generation of the first power headroom, the parameter based on the number of UL PRBs allocated for the PUSCH (the band width of the resource allocated for the PUSCH) is that set for the PUSCH used for the transmission of the first power headroom. To the power headroom generation unit 4057, information and instructions necessary in the generation of the first power headroom are input from the power headroom control unit 4055 and other processing units.

The power headroom generation unit 4057 generates the second power headroom based on the nominal UE maximum transmit power, the path loss input from the path loss calculation unit 4051, the coefficient multiplied by the path loss, the cell-specific and mobile station apparatus-specific parameters notified in advance from the base station apparatus 3 or the RRH 4, and the parameter based on a transmission power control command notified from the base station apparatus 3 or the RRH 4. The power headroom generation unit 4057 calculates assumed transmission power for the PUSCH based on the path loss input from the path loss calculation unit 4051, the coefficient multiplied by the path loss, the cell-specific and mobile station apparatus-specific parameters notified in advance from the base station apparatus 3 or the RRH 4, and the parameter based on a transmission power control command notified from the base station apparatus 3 or the RRH 4. The power headroom generation unit 4057 subtracts the assumed transmission power for the PUSCH from the nominal maximum transmission power of the mobile station, and employs the resultant value as information indicating the second power headroom. The path loss used in the generation of the second power headroom is different from the path loss used in setting the transmission power of the PUSCH used to transmit the second power headroom but is a path loss that is not used in the setting of the transmission power of the PUSCH used to transmit the second power headroom. Note that the first power headroom and the second power headroom are transmitted using the same PUSCH. The power headroom generation unit 4057 generates the second power headroom without depending on the PUSCH and more specifically, without depending on the number of UL PRBs (the band width of the resource) allocated for the PUSCH used in the transmission of the power headrooms (the first power headroom and the second power headroom). To the power headroom generation unit 4057, information and instructions necessary in the generation of the second power headroom are input from the power headroom control unit 4055 and other processing units.

Among parameters associated with the transmission power, the cell-specific and mobile station apparatus-specific parameters, the coefficient multiplied by the path loss, and the offset used for the SRS are notified from the base station apparatus 3 using the PDSCH, while the transmission power control command is notified from the base station apparatus 3 using the PDCCH. The other parameters are calculated from the received signal or based on other information, and are set. The transmission power control command associated with the PUSCH is included in the uplink grant, and the transmission power control command associated with the PUCCH is included in the downlink assignment. Note that the control unit 405 controls the signal configuration of the PUCCH depending on the type of the UCI to be transmitted, and controls the signal configuration of the PUCCH used by the transmission power setting unit 4053. The various parameters associated with the transmission power notified from the base station apparatus 3 are stored in the radio resource control unit 403 as required, and the stored values are input to the transmission power setting unit 4053 and the power headroom generation unit 4057.

The radio resource control unit 403 stores and holds control information generated by the radio resource control unit 103 of the base station apparatus 3 and notified from the base station apparatus 3, and controls the reception processing unit 401 and the transmission processing unit 407 via the control unit 405. That is, the radio resource control unit 403 has a function of a memory for holding various parameters and the like. For example, the radio resource control unit 403 holds parameters associated with transmission power for the PUSCH, the PUCCH, and the SRS, and outputs a control signal to the control unit 405 to control the transmission power setting unit 4053 and the power headroom generation unit 4057 to use the parameters notified from the base station apparatus 3. For example, the radio resource control unit 403 holds information indicating the type of the downlink reference signal used in the measurement of the path loss, and the radio resource control unit 403 outputs a control signal to the control unit 405 to measure the reception quality (RSRP) used in the calculation of the path loss from the downlink reference signal of the type notified from the base station apparatus 3 or the RRH 4.

Under the control of the control unit 405, the transmission processing unit 407 transmits, to the base station apparatus 3, and the signals obtained by encoding and modulating the power headrooms (the first power headroom and the second power headroom), the information data, and the UCI, together with the DM RS, using the resources of PUSCH and PUCCH via the transmitting antenna 411. Furthermore, under the control of the control unit 405, the transmission processing unit 407 transmits an SRS. Furthermore, under the control of the control unit 405, the transmission processing unit 407 transmits a preamble to the base station apparatus 3 or the RRH 4 using the resource of PRACH. Furthermore, under the control of the control unit 405, the transmission processing unit 407 sets the transmission power of the PUSCH, PUC CH, PRACH (description thereof is omitted), DM RS, and SRS. A further detailed description of the transmission processing unit 407 will be given later.

### <Transmission Processing Unit 401 of Mobile Station Apparatus 5>

In the following, details of the reception processing unit 401 of the mobile station apparatus 5 are described. FIG. 5 is a block diagram schematically illustrating a configuration of the reception processing unit 401 of the mobile station apparatus 5 according to the present embodiment of the invention. As illustrated in this figure, the reception processing unit 401 includes a reception RF unit 501, an A/D unit 503, a symbol timing detection unit 505, a GI removal unit 507, a FFT unit 509, a demultiplexing unit 511, a channel estimation unit 513, a PDSCH channel compensation unit 515, a physical downlink shared channel decoding unit 517, a PDCCH channel compensation unit 519, a physical downlink control channel decoding unit 521, and a downlink reception quality measuring unit 531. As illustrated in this figure, the physical downlink shared channel decoding unit 517 includes a data demodulation unit 523, and a turbo decoding unit 525. As illustrated in this figure, the physical downlink control channel decoding unit 521 includes a QPSK demodulator 527, and a Viterbi decoding unit 529.

The reception RF unit 501 properly amplifies a signal received by the receiving antenna 409, converts (down-converts) it into an intermediate frequency, removes unnecessary frequency components, controls the amplification level such that the signal level is maintained proper, and performs a quadrature demodulation based on an in-phase component and a quadrature component of the received signal. The reception RF unit 501 outputs the quadrature-demodulated analog signal to the A/D unit 503.

The A/D unit 503 converts the analog signal quadrature-demodulated by the reception RF unit 501, and outputs the converted digital signal to the symbol timing detection unit 505 and the GI removal unit 507. The symbol timing detection unit 505 detects symbol timing based on the digital signal converted by the A/D unit 503, and outputs a control signal indicating the detected timing of a boundary between symbols to the GI removal unit 507. Based on the control signal from the symbol timing detection unit 505, the GI removal unit 507 removes part corresponding to the guard interval from the digital signal output from the A/D unit 503 and outputs the remaining part of the signal to the FFT unit 509. The FFT unit 509 performs a fast Fourier transform on the signal input from the GI removal unit 507 and performs an OFDM modulation. The FFT unit 509 outputs the resultant signal to the demultiplexing unit 511.

Based on the control signals input from the control unit 405, the demultiplexing unit 511 demultiplexes the signal demodulated by the FFT unit 509 into a PDCCH signal, and a PDSCH signal. The demultiplexing unit 511 outputs the demultiplexed PDSCH signal to the PDSCH channel compensation unit 515, and outputs the demultiplexed PDCCH signal to the PDCCH channel compensation unit 519. Furthermore, the demultiplexing unit 511 demultiplexes downlink resource elements in which the downlink pilot channel is allocated, and outputs the downlink reference signal (CRS, GE specific RS) of the downlink pilot channel to the channel estimation unit 513. On the other hand, the demultiplexing unit 511 outputs the downlink reference signal (CRS, CSI-RS) of the downlink pilot channel to the downlink reception quality measuring unit 531. The demultiplexing unit 511 outputs the PDCCH signal to the PDCCH channel compensation unit 519, and the PDSCH signal to the PDSCH channel compensation unit 515.

The channel estimation unit 513 estimates a change in the channel using a known signal and the downlink reference signal (CRS, UE specific RS) of the downlink pilot channel demultiplexed by the demultiplexing unit 511, and the channel estimation unit 513 outputs channel compensation values used to adjust the amplitude and the phase to compensate for the change in the channels to the PDSCH channel compensation unit 515 and the PDCCH channel compensation unit 519. The channel estimation unit 513 performs the estimation of changes in the channels independently using the CRS and the UE specific RS and outputs a channel compensation value, or the channel estimation unit 513 performs the estimation of a change in the channel using the CRS or the UE specific RS according to an instruction from the base station apparatus 3 and outputs a channel compensation value. In the base station apparatus 3 and the RRH 4, the same precoding process as that used for the UE specific RS is performed for physical channels (PDSCH, E-PDCCH) for which the channel compensation is performed in the mobile station apparatus 5 using the UE specific RS.

The PDSCH channel compensation unit 515 adjusts the amplitude and the phase of the PDSCH signal demultiplexed by the demultiplexing unit 511 according to the channel compensation value input from the channel estimation unit 513. For example, the PDSCH channel compensation unit 515 adjusts the PDSCH signal transmitted using the cooperative multipoint communication according to the channel compensation value generated by the channel estimation unit 513 based on the UE specific RS, while for the PDSCH signal transmitted without using the cooperative multipoint communication, the PDSCH channel compensation unit 515 performs the adjustment according to the channel compensation value generated by the channel estimation unit 513 based on the CRS. The PDSCH channel compensation unit 515 outputs a signal subjected to the channel compensation to the data demodulation unit 523 of the physical downlink shared channel decoding unit 517. Note that for the PDSCH signal transmitted without using the cooperative multipoint communication (without performing the precoding process), the PDSCH channel compensation unit 515 may perform the adjustment according to the channel compensation value generated by the channel estimation unit 513 based on the UE specific RS.

Under the control of the control unit 405, the physical downlink shared channel decoding unit 517 demodulates and decodes the PDSCH thereby detecting information data. The data demodulation unit 523 demodulates the PDSCH signal input from the PDSCH channel compensation unit 515 and outputs the demodulated PDSCH signal to the turbo decoding unit 525. This demodulation is performed according to a demodulation method corresponding to the modulation method employed by the data modulation unit 221 of the base station apparatus 3. The turbo decoding unit 525 decodes the information data from the demodulated PDSCH signal input from the data demodulation unit 523, and outputs the result to a higher-level layer via the control unit 405. Note that the control information and the like generated by the radio resource control unit 103 of the base station apparatus 3 and transmitted using the PDSCH are also output to the control unit 405 and also to the radio resource control unit 403 via the control unit 405. Note that the CRC code included in the PDSCH is also output to the control unit 405.

The PDCCH channel compensation unit 519 adjusts the amplitude and the phase of the PDCCH signal demultiplexed by the demultiplexing unit 511 according to the channel compensation value input from the channel estimation unit 513. For example, the PDCCH channel compensation unit 519 adjusts the PDCCH signal based on the channel compensation value generated by the channel estimation unit 513 based on the CRS. For the PDCCH (E-PDCCH) signal transmitted using the cooperative multipoint communication, the PDCCH channel compensation unit 519 performs the adjustment according to the channel compensation value generated by the channel estimation unit 513 based on the UE specific RS. The PDCCH channel compensation unit 519 outputs the adjusted signal to the QPSK demodulator 527 of the physical downlink control channel decoding unit 521. Note that for the PDCCH (including E-PDCCH) signal transmitted without using the cooperative multipoint communication (without performing the precoding process), the PDCCH channel compensation unit 519 may perform the adjustment according to the channel compensation value generated by the channel estimation unit 513 based on the UE specific RS.

The physical downlink control channel decoding unit 521 demodulates and decodes the signal input from the PDCCH channel compensation unit 519 to detect control data, as described below. The QPSK demodulator 527 performs the QPSK demodulation on the PDCCH signal and outputs the result to the Viterbi decoding unit 529. The Viterbi decoding unit 529 decodes the signal demodulated by the QPSK demodulator 527 and outputs the decoded DCI to the control unit 405. Note that the signal is expressed in units of bits, and the Viterbi decoding unit 529 also performs rate dematching on the input bits to adjust the number of bits to be subjected to the Viterbi decoding process.

The mobile station apparatus 5 performs processes on the PDCCH, for a plurality of assumed encoding ratios, to detect the DCI addressed to the mobile station apparatus 5. The mobile station apparatus 5 performs a plurality of decoding processes, which are different depending on the assumed encoding ratio, on the PDCCH signal, and detects DCI included in PDCCH for which no error is detected in the CRC code added together with DCI to the PDCCH. This process is called blind decoding. Instead of performing the blind decoding for all resource signals in the downlink system band, the mobile station apparatus 5 may perform the blind decoding only for part of the resource signals. The region of the part of the resources for which the blind decoding is performed is referred to as a search space. The mobile station apparatus 5 may perform the blind decoding on resources that are different depending on the encoding ratio.

The control unit 405 determines whether the DCI input from the Viterbi decoding unit 529 does not have an error and whether the DCI is that addressed to the mobile station apparatus 5. In a case where the determination is that the DCI has no error and the DCI is that addressed to the mobile station apparatus 5, then, based on the DCI, the control unit 405 controls the demultiplexing unit 511, the data demodulation unit 523, the turbo decoding unit 525, and the transmission processing unit 407. For example, in a case where the DCI is downlink assignment, the control unit 405 controls the reception processing unit 401 to decode the PDSCH signal. Note that the PDCCH also includes a CRC code as the PDSCH does, and the control unit 405 determines using the CRC code whether the DCI of the PDCCH has an error.

The downlink reception quality measuring unit 531 measures the reception quality (RS RP) of the downlink of the cell using the downlink reference signal (CRS, CSI-RS) of the downlink pilot channel, and outputs the measured reception quality information of the downlink to the control unit 405. In the mobile station apparatus 5, the downlink reception quality measuring unit 531 also performs an instantaneous channel quality measurement to generate CQI to be notified to the base station apparatus 3 or the RRH 4. The downlink reception quality measuring unit 531 is controlled by the base station apparatus 3 or the RRH 4 via the control unit 405 as to which type of downlink reference signal (CRS, CSI-RS, CRS and CSI-RS) is to be used in the measurement of the RSRP. This control is based on information indicating the downlink reference signal used in the measurement of the path loss. For example, the downlink reception quality measuring unit 531 measures the RSRP using the CRS. For example, the downlink reception quality measuring unit 531 measures the RSRP using the CSI-RS. For example, the downlink reception quality measuring unit 531 measures the RSRP using the CRS and measures the RSRP using the CSI-RS. Alternatively, the downlink reception quality measuring unit 531 may continuously measure the RSRP using the CRS, and, in a case where an instruction is issued by the base station apparatus 3 or the RRH 4, the downlink reception quality measuring unit 531 may additionally measure the RSRP using the CSI-RS. The downlink reception quality measuring unit 531 outputs information associated with the measured RSRP and the like to the control unit 405.

### <Transmission Processing Unit 407 of Mobile Station Apparatus 5>

FIG. 6 is a block diagram schematically illustrating a configuration of the transmission processing unit 407 of the mobile station apparatus 5 according to the present embodiment of the invention. As illustrated in this figure, the transmission processing unit 407 includes a turbo encoding unit 611, a data modulation unit 613, a DFT unit 615, an uplink pilot channel processing unit 617, a physical uplink control channel processing unit 619, a subcarrier mapping unit 621, a IFFT unit 623, a GI insertion unit 625, a transmission power adjustment unit 627, a random access channel processing unit 629, a D/A unit 605, a transmission RF unit 607, and a transmitting antenna 411. The transmission processing unit 407 performs encoding and modulation on the information data and the UCI, generates signals to be transmitted using the PUSCH and the PUCCH, and adjusts the transmission power for the PUSCH and the PUCCH. The transmission processing unit 407 generates a signal to be transmitted using the PRACH, and adjusts the transmission power of the PRACH. The transmission processing unit 407 generates a DM RS and an SRS, and adjust the transmission power of the DM RS and the SRS.

The turbo encoding unit 611 performs turbo encoding on the input information data with an encoding ratio specified by the control unit 405 so as to enhance data error resilience, and the turbo encoding unit 611 outputs the result to the data modulation unit 613. The data modulation unit 613 modulates the encoded data encoded by the turbo encoding unit 611 by a modulation method specified by the control unit 405, for example, QPSK, 16 QAM, 64 QAM, or the like thereby generating a signal sequence of modulated symbols. The data modulation unit 613 outputs the generated the signal sequence of modulated symbols to the DFT unit 615. The DFT unit 615 performs a discrete Fourier transform on the signal output by the data modulation unit 613, and outputs the result to the subcarrier mapping unit 621.

The physical uplink control channel processing unit 619 performs baseband signal processing on the UCI which is input from the control unit 405 and which is to be transmitted. The UCI input to the physical uplink control channel processing unit 619 is ACK/NACK, SR, or CQI. The physical uplink control channel processing unit 619 outputs the signal generated via the baseband signal processing to the subcarrier mapping unit 621. The physical uplink control channel processing unit 619 generates a signal by encoding information bits of the UCI.

Furthermore, the physical uplink control channel processing unit 619 performs signal processing associated with code-division multiplexing in the frequency domain and/or code-division multiplexing in the time domain on the signal generated from the UCI. The physical uplink control channel processing unit 619 multiples a PUCCH signal generated from information bits of ACK/NACK, or information bits of SR, or information bits of CQI by a code sequence specified by the control unit 405 to realize code-division multiplexing in the frequency domain. The physical uplink control channel processing unit 619 multiples a PUCCH signal generated from information bits of ACK/NACK or information bits of SR by a code sequence specified by the control unit 405 to realize code-division multiplexing in the time domain.

Under the control of the control unit 405, the uplink pilot channel processing unit 617 generates the SRS and the DM RS which are known by the base station apparatus 3 and outputs the result to the subcarrier mapping unit 621.

Under the control of the control unit 405, the subcarrier mapping unit 621 maps the signal input from the uplink pilot channel processing unit 617, the signal input from the DFT unit 615, and the signal input from the physical uplink control channel processing unit 619 to subcarriers, and the subcarrier mapping unit 621 outputs the result to the IFFT unit 623.

The IFFT unit 623 performs a fast inverse Fourier transform on the signal output by the subcarrier mapping unit 621 and outputs the result to the GI insertion unit 625. In this process, the number of points treated by the IFFT unit 623 is larger than the number of points treated by the DFT unit 615. Using the DFT unit 615, the subcarrier mapping unit 621, and the IFFT unit 623, the mobile station apparatus 5 performs DFT-Spread-OFDM modulation on the signal to be transmitted using the PUSCH. The GI insertion unit 625 adds a guard interval to the signal input from the IFFT unit 623 and outputs the result to the transmission power adjustment unit 627.

The random access channel processing unit 629 generates a signal to be transmitted using the PRACH using a preamble sequence specified by the control unit 405, and outputs the generated signal to the transmission power adjustment unit 627.

Based on the control signal from the control unit 405 (the transmission power setting unit 4053), the transmission power adjustment unit 627 adjusts the transmission power for the signal input from the GI insertion unit 625 or the signal input from the random access channel processing unit 629, and outputs the resultant signal to the D/A unit 605. Note that in the adjustment by the transmission power adjustment unit 627, average transmission power of the PUSCH, PUCCH, DM RS, SRS, and PRACH is controlled for each uplink subframe.

The D/A unit 605 converts the baseband digital signal input from the transmission power adjustment unit 627 into an analog signal and outputs the resultant analog signal to the transmission RF unit 607. The transmission RF unit 607 generates an in-phase component and a quadrature component with the intermediate frequency from the analog signal input from the D/A unit 605, and removes frequency components unnecessary for the intermediate frequency band. Next, the transmission RF unit 607 converts (up-converts) the intermediate frequency signal to a high-frequency signal, removes unnecessary frequency components, performs power amplification, and transmits the resultant signal to the base station apparatus 3 via the transmitting antenna 411.

FIG. 7 is a flow chart illustrating an example of a process of transmitting a power headroom associated with a mobile station apparatus 5 according to the present embodiment of the invention. The mobile station apparatus 5 determines whether transmission of the power headroom is triggered (step S101). In this step, the mobile station apparatus 5 determines whether transmission is triggered for at least either the power headroom using the path loss based on the CRS or the power headroom using the path loss based on the CSI-RS. In a case where it is determined that transmission of the power headroom is triggered (YES in step S101), the mobile station apparatus 5 determines whether a resource for the PUSCH is allocated (step S102). In a case where it is determined that transmission of the power headroom is not triggered (NO in steps S101), the mobile station apparatus 5 does not perform control of transmitting the power headroom. In a case where it is determined that a resource for the PUSCH is allocated (YES in step S102), the mobile station apparatus 5 generates the first power headroom (step S103). Note that the first power headroom is calculated using the path loss used for the PUSCH for which the resource is allocated in step S102. In a case where it is determined that no resource is allocated for the PUSCH (No in step S102), the mobile station apparatus 5 performs the determination again as to whether a resource for the PUSCH is allocated in a next uplink subframe. After the mobile station apparatus 5 generates the first power headroom, the mobile station apparatus 5 generates the second power headroom (step S104). Note that the second power headroom is calculated using a path loss different from the path loss used for the PUSCH for which the resource is allocated in step S102. Note that the generation of the first power headroom and the generation of the second power headroom may be performed in the same uplink subframe, and the generation of the second power headroom may be performed before the generation of the first power headroom. Next, the mobile station apparatus 5 transmits the generated first power headroom and second power headroom using the same PUSCH (step S105). Note that the PUSCH used in step S105 for the transmission of the first power headroom and the second power headroom is the PUSCH for which the resource is allocated in step S102.

As described above, in the present embodiment of the invention, the mobile station apparatus 5 performs control so as to calculate a plurality of path losses based on the CRS (first reference signal) and the CSI-RS (second reference signal), set transmission power for the PUSCH using one of the plurality of path losses, generate the first power headroom using the band width of the resource allocated for the PUSCH and the path loss used in the setting of the transmission power for the PUSCH, generate the second power headroom without depending on the band width of the resource allocated for the PUSCH, using a path loss that is one of the plurality of path losses but that is not used in the setting of the transmission power for the PUSCH, and transmit the first power headroom and the second power headroom using the same PUSCH thereby allowing the base station apparatus 3 and the RRH 4 to be notified, with a small late, of the information associated with the power headrooms for the different path losses, and thus allowing the base station apparatus 3 and the RRH 4 to efficiently perform scheduling (resource allocation for the PUSCH, determination of modulation method) of the uplink for the mobile station apparatus 5. In other words, information associated with the power headroom for each possible destination (the base station apparatus 3 or the RRH 4) of the signal in the uplink is notified to the base station apparatus 3 and the RRH 4 with a small delay, and thus it is possible to efficiently perform scheduling of the uplink in such manners optimum for the respective destinations.

Furthermore, in the present embodiment of the invention, the mobile station apparatus 5 uses common periodicPHR-Timer for the process of transmitting the power headroom using the path loss calculated based on the CRS (first reference signal) and the process of transmitting the power headroom using the path loss calculated based on the CSI-RS (second reference signal), and in a case where the periodicPHR-Timer expires, the mobile station apparatus 5 determines to transmit the power headroom using the path loss calculated based on the CRS (first reference signal) and the power headroom using the path loss calculated based on the CSI-RS (second reference signal), thereby making it possible to notify the base station apparatus 3 and the RRH 4 of information associated with the power headrooms for the different path losses while suppressing the processing load imposed on the mobile station apparatus 5. The mobile station apparatus 5 performs controls such that when a determination is made to transmit the power headroom using the path loss calculated based on the CRS (first reference signal) and the power headroom using the path loss calculated based on the CSI-RS (second reference signal), the first power headroom and the second power headroom are transmitted using a PUSCH for which a resource is allocated first after the determination, thereby allowing the base station apparatus 3 and the RRH 4 to be notified, with a small late, of the information associated with the power headrooms for the different path losses, and thus allowing the base station apparatus 3 and the RRH 4 to efficiently perform scheduling of the uplink for the mobile station apparatus 5.

Furthermore, in the present embodiment of the invention, The mobile station apparatus 5 performs controls such that dl-PathlossChange is checked independently for the path loss calculated based on the CRS (first reference signal) and the path loss calculated based on the CSI-RS (second reference signal), and in a case where either one of the path losses changes by an amount equal to or greater than a corresponding one of pieces of dl-PathlossChange, a determination is made to transmit the power headroom using the path loss calculated based on the CRS (first reference signal) and the power headroom using the path loss calculated based on the CSI-RS (second reference signal). Thereafter, the first power headroom and the second power headroom are transmitted using a PUSCH for which a resource is allocated first after the determination, thereby allowing the base station apparatus 3 and the RRH 4 to be notified, with a small late, of the information associated with the power headrooms for the different path losses, and thus allowing the base station apparatus 3 and the RRH 4 to efficiently perform scheduling of the uplink for the mobile station apparatus 5.

The mobile station apparatus 5 is not limited to a mobile terminal, but the present invention may be applied to a fixed terminal in which the functions of the mobile station apparatus 5 are implemented.

The above-described means characterizing the present invention may also be realized by implementing functions on an integrated circuit and controlling the integrated circuit. That is, the integrated circuit according to the present invention may be an integrated circuit disposed in a mobile station apparatus 5 configured to communicate with a base station apparatus 3 or a RRH 4, wherein the integrated circuit includes a first reception processing unit configured to receive a signal from the base station apparatus 3 or the RRH 4 in a cell, a path loss calculation unit configured to calculate a plurality of path losses based on a CRS (first reference signal) and a CSI-RS (second reference signal) received by the first reception processing unit, a transmission power setting unit configured to set transmission power for a physical uplink shared channel using one of a plurality of the path losses calculated by the path loss calculation unit, a power headroom generation unit configured to generate a first power headroom and a second power headroom, the first power headroom being information associated with a margin of transmission power and produced using a band width of a resource allocated for the physical uplink shared channel and the path loss used in the setting of the transmission power for the physical uplink shared channel, the second power headroom being information associated with a margin of transmission power and produced, without depending on the band width of the resource allocated for the physical uplink shared channel, using a path loss being one of the plurality of path losses calculated by the path loss calculation unit but being not used in the setting of the transmission power for the physical uplink shared channel, and a power headroom control unit configured to control transmission, using the physical uplink shared channel, of the first power headroom and the second power headroom generated by the power headroom generation unit.

The mobile station apparatus 5 using the integrated circuit according to the present invention performs controls so as to calculate a plurality of path losses based on the CRS (first reference signal) and the CSI-RS (second reference signal), set transmission power for the PUSCH using one of the plurality of path losses, generate the first power headroom using the band width of the resource allocated for the PUSCH and the path loss used in the setting of the transmission power for the PUSCH, generate the second power headroom without depending on the band width of the resource allocated for the PUSCH, using a path loss that is one of the plurality of path losses but that is not used in the setting of the transmission power for the PUSCH, and transmit the first power headroom and the second power headroom using the same PUSCH, thereby allowing the base station apparatus 3 and the RRH 4 to be notified, with a small late, of the information associated with the power headrooms for the different path losses, and thus allowing the base station apparatus 3 and the RRH 4 to efficiently perform scheduling (resource allocation for the PUSCH, determination of modulation method) of the uplink for the mobile station apparatus 5. In other words, information associated with the power headroom for each possible destination (the base station apparatus 3 or the RRH 4) of the signal in the uplink is notified to the base station apparatus 3 and the RRH 4 with a small delay, and thus it is possible to efficiently perform scheduling of the uplink in manners optimized for the respective destinations.

### Second Embodiment

A second embodiment of the present invention is different from the first embodiment in downlink reference signals used in measurement of a plurality of path losses. In the second embodiment, each of the plurality of path losses is calculated based on a CSI-RS, and more specifically respective path losses are calculated based on CSI-RSs (first reference signal, second reference signal) corresponding to different antenna ports. The mobile station apparatus 5 receives, from the base station apparatus 3 or the RRH 4, a notification specifying antenna ports (including a plurality of antenna ports) associated with the CSI-RSs used in the measurement of the respective path losses. Part of the CSI-RSs is transmitted only from an antenna port of the base station apparatus 3, while part of the CSI-RSs is transmitted only from the RRH 4. According to the specifications by the base station apparatus 3 and the RRH 4, the mobile station apparatus 5 calculates one path loss based on the CSI-RS transmitted only from the antenna port of the base station apparatus 3, while the mobile station apparatus 5 calculates the other path loss based on the CSI-RS transmitted only from the antenna port of the RRH 4.

The mobile station apparatus 5 sets the transmission power for the PUSCH to a desired value using one of the path losses calculated based on the CSI-RSs of the different antenna ports. For example, in a case where the PUSCH is directed to the base station apparatus 3, the path loss calculated based on the CSI-RS transmitted only from the antenna port of the base station apparatus 3 is used for the PUSCH. In a case where the PUSCH is directed to the RRH 4, the path loss calculated based on the CSI-RS transmitted only from the antenna port of the RRH 4 is used for the PUSCH.

The mobile station apparatus 5 generates a first power headroom and a second power headroom using the plurality of path losses calculated based on the CSI-RSs corresponding to the different antenna ports, and transmits the generated first power headroom and the second power headroom. For example, the mobile station apparatus 5 generates the first power headroom using the path loss calculated based on the CSI-RS transmitted only from the antenna port of the base station apparatus 3, and generates the second power headroom using the path loss calculated based on the CSI-RS transmitted only from the antenna port of the RRH 4. For example, the mobile station apparatus 5 generates the first power headroom using the path loss calculated based on the CSI-RS transmitted only from the antenna port of the RRH 4, and generates the second power headroom using the path loss calculated based on the CSI-RS transmitted only from the antenna port of the base station apparatus 3.

In the second embodiment, also in a case where path losses are calculated based on CSI-RSs corresponding to different antenna ports, the mobile station apparatus 5 generates the first power headroom and the second power headroom and transmits the first power headroom and the second power headroom to the base station apparatus 3 and the RRH 4, thereby allowing it to achieve advantageous effects similar to those achieved by the first embodiment. It is possible to efficiently perform scheduling of the uplink in manners optimized for the respective destinations.

CSI-RSs corresponding to substantially different antenna ports may not denoted explicitly by antenna port numbers in one CSI-RS configuration associated with the antenna ports, but, instead, the CSI-RSs may be informed to the mobile station apparatus 5 by different CSI-RS configurations. For example, a plurality of CSI-RS configurations (CSI-RS-Config-r10) are notified to the mobile station apparatus 5. The number of antenna ports set in CSI-RS may be equal for all CSI-RS configurations, that is, the antenna port numbers may be equal among all CSI-RS configurations. For example, in the CSI-RS configuration, CSI-RSs are mapped to different downlink subframes. For example, in the CSI-RS configuration, CSI-RSs are mapped in different areas in the frequency domain.

For example, a CSI-RS configuration is substantially a CSI-RS configuration transmitted only from an antenna port of the base station apparatus 3. For example, a CSI-RS configuration is substantially a CSI-RS configuration transmitted only from an antenna port of the RRH 4. It may be sufficient to notify the mobile station apparatus 5 of a plurality of CSI-RS configurations, but explicit information may not be given as to whether the CSI-RS configuration is transmitted only from an antenna port of the base station apparatus 3 or only from an antenna port of the RRH 4.

The mobile station apparatus 5 sets the transmission power for the PUSCH to a desired value using one of the path losses calculated based on the CSI-RSs width different configurations. For example, in a case where the PUSCH is directed to the base station apparatus 3, the path loss calculated based on the CSI-RS transmitted only from the antenna port of the base station apparatus 3 is used in the setting of the transmission power to the desired value. In a case where the PUSCH is directed to the RRH 4, the path loss calculated based on the CSI-RS transmitted only from the antenna port of the RRH 4 is used in the setting of the transmission power to the desired value. Note that the mobile station apparatus 5 may be notified from the base station apparatus 3 or the RRH 4 only as to information indicating which one of CSI-RS configurations is used in calculating a path loss based on which transmission power for PUSCH is set to a desired value, and explicit information may not be given as to whether the PUSCH is directed to the base station apparatus 3 or the RRH 4.

The mobile station apparatus 5 generates a first power headroom and a second power headroom using the plurality of path losses calculated based on the CSI-RSs with different configurations (a first CSI-RS configuration and a second CSI-RS configuration), and transmits the generated first power headroom and the second power headroom. For example, the mobile station apparatus 5 generates the first power headroom using the path loss calculated based on the CSI-RS with the first CSI-RS configuration and generates the second power headroom using the path loss calculated based on the CSI-RS with the second CSI-RS configuration. For example, the mobile station apparatus 5 generates the first power headroom using the path loss calculated based on the CSI-RS with the second CSI-RS configuration and generates the second power headroom using the path loss calculated based on the CSI-RS with the first CSI-RS configuration. More specifically, for example, the mobile station apparatus 5 generates the first power headroom using the path loss calculated based on the CSI-RS transmitted only from the antenna port of the base station apparatus 3, and generates the second power headroom using the path loss calculated based on the CSI-RS transmitted only from the antenna port of the RRH 4. More specifically, for example, the mobile station apparatus 5 generates the first power headroom using the path loss calculated based on the CSI-RS transmitted only from the antenna port of the RRH 4, and generates the second power headroom using the path loss calculated based on the CSI-RS transmitted only from the antenna port of the base station apparatus 3.

Thus also in the case where path losses are calculated respectively based on CSI-RSs with different configurations, the mobile station apparatus 5 generates the first power headroom and the second power headroom and transmits the first power headroom and the second power headroom to the base station apparatus 3 and the RRH 4, thereby allowing it to achieve advantageous effects similar to those achieved by the first embodiment. It is possible to efficiently perform scheduling of the uplink in manners optimized for respective destinations.

Alternatively, the mobile station apparatus 5 in a state in which a path loss is measured based on a CSI-RS with a certain configuration, in a case where a process of measuring a path loss based on a CSI-RS with a different configuration is additionally set, the mobile station apparatus 5 may go into a state of waiting for a chance to start transmitting the power headroom. In this case, at least a power headroom based on the path loss corresponding to the added process goes in to the transmission waiting state. Furthermore, a power headroom based on the path loss corresponding to the originally set process may also go into the transmission waiting state.

The frequency bands used may be different between the base station apparatus 3 and the RRH 4, and cooperative multipoint communication may be performed among different RRHs 4. For example, the mobile station apparatus 5 transmits the signal in the uplink with transmission power optimum for the signal to be received by the respective RRHs 4.

In a case where different frequency bands used are different between a cell supported by the base station apparatus 3 and cells supported by the RRHs 4, only CSI-RS may be used for the cells of the RRHs 4 without using CRS. In this case, for example, the mobile station apparatus 5 may perform the process for the cells of the RRHs 4 such that the process of calculating a path loss based on CRS and calculating a value of transmission power for the uplink using the calculated path loss is not employed in an initial state (default state), but the process of calculating a path loss based on CSI-RS and calculating a value of transmission power for the uplink using the calculated path loss is employed in the initial state (default state). In a case where the base station apparatus 5 determines that it is necessary to add a RRH 4 for use in cooperative multipoint communication to the mobile station apparatus 5, the base station apparatus 5 notifies the mobile station apparatus 5 of the configuration of the CSI-RS for a cell supported by that RRH 4, and the base station apparatus 5 performs addition/change (resetting, reconfiguration) of a path loss reference for the mobile station apparatus 5.

CSI-RS configurations for RRHs 4 may be different among different RRHs 4. For example, when different CSI-RS configurations are used for different RRHs 4, CSI-RSs may be mapped to different downlink subframes. For example, when different CSI-RS configurations are used for different RRHs 4, CSI-RSs may be mapped to different frequency bands. For example, when different CSI-RS configurations are used for different RRHs 4, the number of antenna ports of CSI-RS may be different. Information associated with the CSI-RS configuration for each RRH 4 involved in the cooperative multipoint communication is notified to the mobile station apparatus 5 from the base station apparatus 3. Based on the notified CSI-RS configuration, the mobile station apparatus 5 receives the CSI-RS transmitted from each RRH 4, measures the path loss associated with the RRH 4, and sets transmission power for the signal in the uplink using the measured path loss. This makes it possible for the mobile station apparatus 5 to optimally set the transmission power for each RRH 4 to which the signal is transmitted. By optimally setting the transmission power for each RRH 4 to which the signal is transmitted, it is possible to suppress the interference to other signals while satisfying required signal quality thereby improving the efficiency of the communication system. As described above, the present invention may also be applied to a communication system in which the mobile station apparatus 5 measures a plurality of path losses from a plurality of types of downlink reference signals, and the mobile station apparatus 5 controls transmission power of a signal in the uplink using one of or respective path losses. More specifically, the mobile station apparatus 5 may measure a plurality of path losses from a plurality of CSI-RSs with different CSI-RS configurations, and control the transmission power of the signal in the uplink using one of path losses or using each path loss.

For example, a practical CSI-RS configuration is one specifying that transmission is performed only from an antenna port of a first RRH 4. For example, a CSI-RS configuration is substantially a CSI-RS configuration transmitted only from an antenna port of a second RRH 4. It may be sufficient to notify the mobile station apparatus 5 of a plurality of CSI-RS configurations, but the mobile station apparatus 5 may not need to be explicitly informed as to which RRH 4 with antenna ports is involved in the CSI-RS configuration.

The mobile station apparatus 5 sets the transmission power for the PUSCH to a desired value using one of the path losses calculated based on the CSI-RSs width different configurations. For example, in a case where the PUSCH is directed to the first RRH 4, the path loss calculated based on the CSI-RS transmitted only from the antenna port of the first RRH 4 is used in the setting of the transmission power to the desired value. In a case where the PUSCH is directed to the second RRH 4, the path loss calculated based on the CSI-RS transmitted only from the antenna port of the second RRH 4 is used in the setting of the transmission power of the PSCCH to the desired value. Note that the mobile station apparatus 5 may be notified from the base station apparatus 3 or the RRH 4 only as to information indicating which one of CSI-RS configurations is used in calculating a path loss based on which transmission power for PUSCH is set to a desired value, and explicit information may not be given as to which one of the RRHs 4 is a destination of the PUSCH.

Operations in the embodiments of the invention may be realized by a program. The program that operates in the mobile station apparatus 5 and the base station apparatus 3 according to the present invention is a program configured to control a CPU or the like (a program configured to cause a computer to function) such that functions of the above-described embodiments of the invention are realized. Information treated with by such apparatuses is stored temporarily in a RAM when a process is performed. Thereafter, the information is stored in various ROMs or a HDD, read out by the CPU as required, and modified and written. As for a medium for storing the program, any of the following may be used: a semiconductor medium (for example, a ROM, a nonvolatile memory cord, or the like); an optical storage medium (for example, DVD, MO, MD, CD, BD, or the like); and a magnetic storage medium (for example, a magnetic tape, a flexible disk, or the like) or the like. Not only the functions of the embodiments described above are realized by executing the loaded program, but the functions of the invention may also be realized by performing a process in cooperation with an operating system or another application program or the like according to an instruction of the program.

To distribute the program in market, the program may be stored in a portable storage medium and distributed, or the program may be transferred to a server computer connected via a network such as the Internet or the like. In this case, a storage apparatus of the server computer also falls within the scope of the present invention. Part or all of the mobile station apparatus 5 and the base station apparatus 3 according to the embodiments described above may be realized by a LSI which is a typical integrated circuit. The respective functional blocks of the mobile station apparatus 5 and the base station apparatus 3 may be individually realized on separate chips, or part or all of functions may be integrated on a chip. The method of realizing the integrated circuit is not limited to the LSI, but the functions may be implemented by a dedicated circuit or general-purpose processor. If the progress of the semiconductor technology provides a technology for implementing an integrated circuit which replaces the LSI, the integrated circuit based on this technology may also be used. The respective functional blocks of the mobile station apparatus 5 and the base station apparatus 3 may be individually realized by a plurality of circuits.

Information and signals may be represented using various different techniques or methods. For example, chips, symbols, bits, signals, information, commands, instructions, and data described above may be represented by voltages, currents, electromagnetic waves, magnetic fields, magnetic particles, optical fields, optical particles, or combinations thereof.

Logical blocks, processing units, and algorithm steps disclosed above by way of example in the present description may be implemented by electronic hardware, computer software, or a combination thereof. To clearly illustrate equivalent between hardware and software, various examples of elements, blocks, modules, circuits, and steps have been generally described in terms of their functionalities. Whether such functionalities are implemented by hardware or software depends on individual applications and restrictions imposed on design of an overall system. Those skilled in the art may implement the functionalities for specific applications by various methods. It should not be understood that such various methods of implementing the functionalities do not fall within the scope of the invention.

Various logical blocks and processing units disclosed by way of example in the present description may be implemented or executed by a device designed to execute the functions described above, and more specifically, such as a general-purpose processor, a digital signal processor (DSP), an application specific integrated circuit (ASIC), a field programmable gate array signal (FPGA), or other programmable logic devices, discrete or gates or transistor logic, a discrete hardware component, or a combination thereof. The general-purpose processor may be a microprocessor, or alternatively, the processor may be a conventional processor, a controller, a microcontroller, or a state machine. The processor may also be implemented by a combination of computing devices. For example, a combination of a DSP and a microprocessor, a combination of a plurality of microprocessors, a combination of a DSP core and one or more microprocessors connected to the DSP core, or a combination of other similar devices.

Steps of methods or algorithms disclosed in the present description may be directly executed by hardware, a software module executed by a processor, or a combination of these. The software modules may be stored in a RAM memory, a flash memory, a ROM memory, an EPROM memory, an EEPROM memory, a register, a hard disk, a removable disk, a CD-ROM, or a storage medium of any type known in the present technical field. A typical storage medium is capable of being connected to a processor such that the processor is allowed to read information from the storage medium and write information in the storage medium. Alternatively, the storage medium may be integrated with the processor. The processor and the storage medium may be disposed in an ASIC. The ASIC may be disposed in a mobile station apparatus (user terminal). Alternatively, the processor and the storage medium may be disposed as discrete elements in the mobile station apparatus 5.

In one or more typical designs, the functions described above may be implemented by hardware, software, firmware, or a combination thereof. In a case where the functions are implemented by software, the functions may be held or transmitted as one or more commands or codes on a computer-readable medium. The computer-readable media include both a computer storage medium and a communication medium including a medium by which the computer program is allowed to be transferred. The storage medium may be any type of commercially available medium capable of being accessed by a general-purpose or specific-purpose computer. Examples of such computer-readable media include, although not limited to, a RAM, a ROM, an EEPROM, a CDROM, or other types of optical disk media, magnetic disk medium or other types of magnetic storage media, and a medium configured to be accessible by a general-purpose or specific-purpose computer or a general-purpose or specific-purpose processor and configured to be usable to carry or store desired program code means in the form of a command or a data structure. Note that any connection may be called a proper computer-readable medium. For example, in a case where software is transmitted from a web site, a server, or other remote sources using a coaxial cable, an optical fiber cable, a twisted pair cable, a digital subscriber line (DSL), or a wireless connection medium using an infrared ray, a radio wave, a microwave, or the like, then such the coaxial cable, the optical fiber cable, the twisted pair cable, the DSL, and the wireless connection medium using the infrared ray, the radio wave, the microwave, or the like, fall within the scope of the medium. The disks (discs) used in the present description include a compact disk (CD), a laser disk (registered trademark), an optical disk, a digital versatile disk (DVD), a floppy (registered trademark) disk, and a Blu-ray disk. The disk is generally configured to be capable of magnetically reading out data. Alternatively, the disk may be configured to be capable of optically reading out data using a laser. It should be understood that a combination of the above-described disks also falls within the scope of the computer-readable storage medium.

While the embodiments of the present invention have been described in detail with reference to the drawings, the invention is not limited to the details of the embodiments,

### REFERENCE SIGNS LIST

3 base station apparatus
4 (A to C) RRH
5 (A to C) mobile station apparatus
101 reception processing unit
103 radio resource control unit
105 control unit
107 transmission processing unit
109 receiving antenna
111 transmitting antenna
201, 201-1 to 201-M physical downlink shared channel processing unit
203, 203-1 to 203-M physical downlink control channel processing unit
205 downlink pilot channel processing unit
207 multiplexing unit
209 IFFT unit
211 GI insertion unit
213 D/A unit
215 transmission RF unit
219 turbo encoding unit
221 data modulation unit
223 convolutional encoding unit
225 QPSK modulation unit
227 precoding processing unit (for PDCCH)
229 precoding processing unit (for PDSCH)
231 precoding processing unit (for downlink pilot channel)
301 reception RF unit
303 A/D unit
309 symbol timing detection unit
311 GI removal unit
313 FFT unit
315 subcarrier demapping unit
317 channel estimation unit
319 channel equalization unit (for PUSCH)
321 channel equalization unit (for PUCCH)
323 IDFT unit
325 data demodulation unit
327 turbo decoding unit
329 physical uplink control channel detection unit
331 preamble detection unit
333 SRS processing unit
401 reception processing unit
403 radio resource control unit
405 control unit
407 transmission processing unit
409 receiving antenna
411 transmitting antenna
501 reception RF unit
503 A/D unit
505 symbol timing detection unit
507 GI removal unit
509 FFT unit
511 demultiplexing unit
513 channel estimation unit
515 channel compensation unit (for PDSCH)
517 physical downlink shared channel decoding unit
519 channel compensation unit (for PDCCH)
521 physical downlink control channel decoding unit
523 data demodulation unit
525 turbo decoding unit
527 QPSK demodulator
529 Viterbi decoding unit
531 downlink reception quality measuring unit
605 D/A unit
607 transmission RF unit
611 turbo encoding unit
613 data modulation unit
615 DFT unit
617 uplink pilot channel processing unit
619 physical uplink control channel processing unit
621 subcarrier mapping unit
623 IFFT unit
625 GI insertion unit
627 transmission power adjustment unit
629 random access channel processing unit
4051 path loss calculation unit
4053 transmission power setting unit
4055 power headroom control unit
4057 power headroom generation unit

1-10. (canceled)

11. A mobile station apparatus configured to communicate with at least one base station apparatus, comprising:
a first reception processing unit configured to receive a signal from the base station apparatus in a cell;
wherein the signal includes a first reference signal and a second reference signal provided in the same cell,
the mobile station apparatus further comprising:
a path loss calculation unit configured to calculate a plurality of path losses based on the first reference signal and the second reference signal received by the first reception processing unit;
a transmission power setting unit configured to set transmission power for a physical uplink shared channel in the cell, using one of a plurality of the path losses calculated by the path loss calculation unit;
a power headroom generation unit configured to generate a first power headroom and a second power headroom, the first power headroom being information associated with a margin of transmission power and produced using a band width of a resource allocated for the physical uplink shared channel and the path loss used in the setting of the transmission power for the physical uplink shared channel, the second power headroom being information associated with a margin of transmission power and produced, without depending on the band width of the resource allocated for the physical uplink shared channel, using a path loss being one of the plurality of path losses calculated by the path loss calculation unit but being not used in the setting of the transmission power for the physical uplink shared channel; and
a power headroom control unit configured to control transmission, using the physical uplink shared channel, of the first power headroom and the second power headroom generated by the power headroom generation unit.

12. The mobile station apparatus according to claim 11, wherein the first reference signal and the second reference signal are respectively Channel State Information Reference Signals (CSI-RSs) with different configurations.

13. A communication method used in a mobile station apparatus configured to communicate with at least one base station apparatus, comprising at least the steps of:
in a cell, receiving a signal from the base station apparatus;
wherein the signal includes a first reference signal and a second reference signal provided in the same cell,
calculating a plurality of path losses based on the received first reference signal and the received second reference signal;
setting transmission power for a physical uplink shared channel in the cell, using one of the plurality of calculated path losses;
generating a first power headroom and a second power headroom, the first power headroom being information associated with a margin of transmission power and produced using a band width of a resource allocated for the physical uplink shared channel and the path loss used in the setting of the transmission power for the physical uplink shared channel, the second power headroom being information associated with a margin of transmission power and produced, without depending on the band width of the resource allocated for the physical uplink shared channel, using a path loss being one of the plurality of path losses calculated but being not used in the setting of the transmission power for the physical uplink shared channel; and
controlling transmission, using the physical uplink shared channel, of the generated first power headroom and the generated second power headroom.

14. The communication method according to claim 13, wherein the first reference signal and the second reference signal are respectively Channel State Information Reference Signals (CSI-RSs) with different configurations.

15. An integrated circuit disposed in a mobile station apparatus configured to communicate with at least one base station apparatus, the integrated circuit configured to implement a plurality of functions in the mobile station apparatus, the functions comprising:
a function of, in a cell, receiving a signal from the base station apparatus;
wherein the signal includes a first reference signal and a second reference signal provided in the same cell,
the functions further comprising:
a function of calculating a plurality of path losses based on the received first reference signal and the received second reference signal;
a function of setting transmission power for a physical uplink shared channel in the cell, using one of the plurality of calculated path losses;
a function of generating a first power headroom and a second power headroom, the first power headroom being information associated with a margin of transmission power and produced using a band width of a resource allocated for the physical uplink shared channel and the path loss used in the setting of the transmission power for the physical uplink shared channel, the second power headroom being information associated with a margin of transmission power and produced, without depending on the band width of the resource allocated for the physical uplink shared channel, using a path loss being one of the plurality of path losses calculated but being not used in the setting of the transmission power for the physical uplink shared channel; and
a function of controlling transmission, using the physical uplink shared channel, of the generated first power headroom and the generated second power headroom.

16. The integrated circuit according to claim 15, wherein the first reference signal and the second reference signal are respectively Channel State Information Reference Signals (CSI-RSs) with different configurations.
